(19) United States
(12) Patent Application Publication
(10) Pub. No.: US 2025/0217026 A1
(43) Pub. Date: Jul. 3, 2025

(54) TECHNIQUES FOR PROVIDING INPUT MECHANISMS

(71) Applicant: Apple Inc., Cupertino, CA (US)

(72) Inventors: Arian BEHZADI, San Francisco, CA (US); Matthew J. ALLEN, Menlo Park, CA (US); Karlin Y. BARK, San Carlos, CA (US); Daniel DE ROCHA ROSARIO, San Francisco, CA (US); John FIELD, Los Gatos, CA (US); Tom HSU, Santa Clara, CA (US); Julian JAEDE, San Jose, CA (US); Andrew S. KIM, Walnut Creek, CA (US); Andrew W. KOOKER, San Francisco, CA (US); Stephen B. LYNCH, Portola Valley, CA (US); Daamun MOHSENI, Campbell, CA (US); Jean-Pierre M. MOUILLESEAUX, San Carlos, CA (US); Trevor K. NIELSEN, Redwood City, CA (US); Jeffrey M. RIEPLING, San Jose, CA (US); Gemma A. ROPER, San Francisco, CA (US); Megan M. SAPP, Napa, CA (US); Jeffrey A. SEWELL, Wyandotte, MI (US); Ronak J. SHAH, Sunnyvale, CA (US); Kurt R. STIEHL, Los Gatos, CA (US); Steven J. TAYLOR, Los Gatos, CA (US); Corey K. WANG, Palo Alto, CA (US)

(21) Appl. No.: 19/087,377

(22) Filed: Mar. 21, 2025

Related U.S. Application Data
(63) Continuation of application No. PCT/US23/33568, filed on Sep. 24, 2023.
(60) Provisional application No. 63/409,753, filed on Sep. 24, 2022.

(51) Int. Cl. G06F 3/04847; G06F 3/01; G06F 3/0488

(52) U.S. Cl. CPC G06F 3/04847; G06F 3/016; G06F 3/0488

(57) ABSTRACT

The present disclosure generally relates to techniques for providing input mechanisms.

### CROSS-REFERENCE TO RELATED APPLICATIONS

This application is a continuation of PCT Application No. PCT/US2023/033568, entitled “TECHNIQUES FOR PROVIDING INPUT MECHANISMS,” filed Sep. 24, 2023, which claims priority to U.S. Provisional Patent Application No. 63/409,753, entitled “TECHNIQUES FOR PROVIDING INPUT MECHANISMS,” filed Sep. 24, 2022, the contents of each which are hereby incorporated by reference in their entireties for all purposes.

### BACKGROUND

### Field

The present disclosure relates generally to techniques for providing input mechanisms.

### Description of Related Art

Various hardware exists for interacting with platforms and/or computer systems, such as touch-sensitive displays, keyboards, and mouses. Such hardware can be controlled and/or programmed to allow for user interaction with a platform and/or a computer system under various circumstances.

### BRIEF SUMMARY

In accordance with some embodiments, a method is described. The method comprises: receiving, via a first input mechanism corresponding to a first user of a plurality of users, a first user input; in response to receiving the first user input via the first input mechanism corresponding to the first user: in accordance with a determination that a first set of criteria are satisfied, modifying a first characteristic for the first user without modifying the first characteristic for a second user of the plurality of users; and in accordance with a determination that a second set of criteria different from the first set of criteria are satisfied, modifying a second characteristic for the first user and for the second user.

In accordance with some embodiments, a non-transitory computer-readable storage medium is described. The non-transitory computer-readable storage medium stores one or more programs configured to be executed by one or more processors of a computer system, and the one or more programs include instructions for: receiving, via a first input mechanism corresponding to a first user of a plurality of users, a first user input; in response to receiving the first user input via the first input mechanism corresponding to the first user: in accordance with a determination that a first set of criteria are satisfied, modifying a first characteristic for the first user without modifying the first characteristic for a second user of the plurality of users; and in accordance with a determination that a second set of criteria different from the first set of criteria are satisfied, modifying a second characteristic for the first user and for the second user.

In accordance with some embodiments, a transitory computer-readable storage medium is described. The transitory computer-readable storage medium stores one or more programs configured to be executed by one or more processors of a computer system, and the one or more programs include instructions for: receiving, via a first input mechanism corresponding to a first user of a plurality of users, a first user input; in response to receiving the first user input via the first input mechanism corresponding to the first user: in accordance with a determination that a first set of criteria are satisfied, modifying a first characteristic for the first user without modifying the first characteristic for a second user of the plurality of users; and in accordance with a determination that a second set of criteria different from the first set of criteria are satisfied, modifying a second characteristic for the first user and for the second user.

In accordance with some embodiments, a computer system is described. The computer system comprises: one or more processors; and memory storing one or more programs configured to be executed by the one or more processors, the one or more programs including instructions for: receiving, via a first input mechanism corresponding to a first user of a plurality of users, a first user input; in response to receiving the first user input via the first input mechanism corresponding to the first user: in accordance with a determination that a first set of criteria are satisfied, modifying a first characteristic for the first user without modifying the first characteristic for a second user of the plurality of users; and in accordance with a determination that a second set of criteria different from the first set of criteria are satisfied, modifying a second characteristic for the first user and for the second user.

In accordance with some embodiments, a computer system is described. The computer system comprises: means for receiving, via a first input mechanism corresponding to a first user of a plurality of users, a first user input; means for, in response to receiving the first user input via the first input mechanism corresponding to the first user: in accordance with a determination that a first set of criteria are satisfied, modifying a first characteristic for the first user without modifying the first characteristic for a second user of the plurality of users; and in accordance with a determination that a second set of criteria different from the first set of criteria are satisfied, modifying a second characteristic for the first user and for the second user.

In accordance with some embodiments, a computer program product is described. The computer program product comprises one or more programs configured to be executed by one or more processors of a computer system, the one or more programs including instructions for: receiving, via a first input mechanism corresponding to a first user of a plurality of users, a first user input; in response to receiving the first user input via the first input mechanism corresponding to the first user: in accordance with a determination that a first set of criteria are satisfied, modifying a first characteristic for the first user without modifying the first characteristic for a second user of the plurality of users; and in accordance with a determination that a second set of criteria different from the first set of criteria are satisfied, modifying a second characteristic for the first user and for the second user.

In accordance with some embodiments, a method is described. The method comprises: while receiving, via a rotatable input mechanism, a first user input to modify a characteristic of a vehicle: in accordance with a determination that a first set of criteria are satisfied, applying a first set of mechanical rotation properties on the rotatable input mechanism; and in accordance with a determination that a second set of criteria different from the first set of criteria are satisfied, applying a second set of mechanical rotation properties different from the first set of mechanical rotation properties on the rotatable input mechanism.

In accordance with some embodiments, a non-transitory computer-readable storage medium is described. The non-transitory computer-readable storage medium stores one or more programs configured to be executed by one or more processors of a computer system, and the one or more programs include instructions for: while receiving, via a rotatable input mechanism, a first user input to modify a characteristic of a vehicle: in accordance with a determination that a first set of criteria are satisfied, applying a first set of mechanical rotation properties on the rotatable input mechanism; and in accordance with a determination that a second set of criteria different from the first set of criteria are satisfied, applying a second set of mechanical rotation properties different from the first set of mechanical rotation properties on the rotatable input mechanism.

In accordance with some embodiments, a transitory computer-readable storage medium is described. The transitory computer-readable storage medium stores one or more programs configured to be executed by one or more processors of a computer system, and the one or more programs include instructions for: while receiving, via a rotatable input mechanism, a first user input to modify a characteristic of a vehicle: in accordance with a determination that a first set of criteria are satisfied, applying a first set of mechanical rotation properties on the rotatable input mechanism; and in accordance with a determination that a second set of criteria different from the first set of criteria are satisfied, applying a second set of mechanical rotation properties different from the first set of mechanical rotation properties on the rotatable input mechanism.

In accordance with some embodiments, a computer system is described. The computer system comprises: one or more processors; and memory storing one or more programs configured to be executed by the one or more processors, the one or more programs including instructions for: while receiving, via a rotatable input mechanism, a first user input to modify a characteristic of a vehicle: in accordance with a determination that a first set of criteria are satisfied, applying a first set of mechanical rotation properties on the rotatable input mechanism; and in accordance with a determination that a second set of criteria different from the first set of criteria are satisfied, applying a second set of mechanical rotation properties different from the first set of mechanical rotation properties on the rotatable input mechanism.

In accordance with some embodiments, a computer system is described. The computer system comprises: means for, while receiving, via a rotatable input mechanism, a first user input to modify a characteristic of a vehicle: in accordance with a determination that a first set of criteria are satisfied, applying a first set of mechanical rotation properties on the rotatable input mechanism; and in accordance with a determination that a second set of criteria different from the first set of criteria are satisfied, applying a second set of mechanical rotation properties different from the first set of mechanical rotation properties on the rotatable input mechanism.

In accordance with some embodiments, a computer program product is described. The computer program product comprises one or more programs configured to be executed by one or more processors of a computer system, the one or more programs including instructions for: while receiving, via a rotatable input mechanism, a first user input to modify a characteristic of a vehicle: in accordance with a determination that a first set of criteria are satisfied, applying a first set of mechanical rotation properties on the rotatable input mechanism; and in accordance with a determination that a second set of criteria different from the first set of criteria are satisfied, applying a second set of mechanical rotation properties different from the first set of mechanical rotation properties on the rotatable input mechanism.

In accordance with some embodiments, a method is described. The method comprises: detecting, via one or more input devices, a user satisfies proximity criteria relative to a platform; and in response to detecting that the user satisfies proximity criteria relative to the platform: in accordance with a determination that the user is identified as a first user, displaying, via one or more display generation components, first content; and in accordance with a determination that the user is not identified as the first user, displaying, via the one or more display generation components, second content different from the first content.

In accordance with some embodiments, a non-transitory computer-readable storage medium is described. The non-transitory computer-readable storage medium stores one or more programs configured to be executed by one or more processors of a computer system, and the one or more programs include instructions for: detecting, via one or more input devices, a user satisfies proximity criteria relative to a platform; and in response to detecting that the user satisfies proximity criteria relative to the platform: in accordance with a determination that the user is identified as a first user, displaying, via one or more display generation components, first content; and in accordance with a determination that the user is not identified as the first user, displaying, via the one or more display generation components, second content different from the first content.

In accordance with some embodiments, a transitory computer-readable storage medium is described. The transitory computer-readable storage medium stores one or more programs configured to be executed by one or more processors of a computer system, and the one or more programs include instructions for: detecting, via one or more input devices, a user satisfies proximity criteria relative to a platform; and in response to detecting that the user satisfies proximity criteria relative to the platform: in accordance with a determination that the user is identified as a first user, displaying, via one or more display generation components, first content; and in accordance with a determination that the user is not identified as the first user, displaying, via the one or more display generation components, second content different from the first content.

In accordance with some embodiments, a computer system is described. The computer system comprises: one or more processors; and memory storing one or more programs configured to be executed by the one or more processors, the one or more programs including instructions for: detecting, via one or more input devices, a user satisfies proximity criteria relative to a platform; and in response to detecting that the user satisfies proximity criteria relative to the platform: in accordance with a determination that the user is identified as a first user, displaying, via one or more display generation components, first content; and in accordance with a determination that the user is not identified as the first user, displaying, via the one or more display generation components, second content different from the first content.

In accordance with some embodiments, a computer system is described. The computer system comprises: means for detecting, via one or more input devices, a user satisfies proximity criteria relative to a platform; and means for, in response to detecting that the user satisfies proximity criteria relative to the platform: in accordance with a determination that the user is identified as a first user, displaying, via one or more display generation components, first content; and in accordance with a determination that the user is not identified as the first user, displaying, via the one or more display generation components, second content different from the first content.

In accordance with some embodiments, a computer program product is described. The computer program product comprises one or more programs configured to be executed by one or more processors of a computer system, the one or more programs including instructions for: detecting, via one or more input devices, a user satisfies proximity criteria relative to a platform; and in response to detecting that the user satisfies proximity criteria relative to the platform: in accordance with a determination that the user is identified as a first user, displaying, via one or more display generation components, first content; and in accordance with a determination that the user is not identified as the first user, displaying, via the one or more display generation components, second content different from the first content.

In accordance with some embodiments, a method is described. The method comprises: in accordance with a determination that a first set of criteria are satisfied, extending a first input mechanism from a first surface; and in accordance with a determination that a second set of criteria different from the first set of criteria are satisfied, forgoing extending the first input mechanism from the first surface.

In accordance with some embodiments, a non-transitory computer-readable storage medium is described. The non-transitory computer-readable storage medium stores one or more programs configured to be executed by one or more processors of a computer system, and the one or more programs include instructions for: in accordance with a determination that a first set of criteria are satisfied, extending a first input mechanism from a first surface; and in accordance with a determination that a second set of criteria different from the first set of criteria are satisfied, forgoing extending the first input mechanism from the first surface.

In accordance with some embodiments, a transitory computer-readable storage medium is described. The transitory computer-readable storage medium stores one or more programs configured to be executed by one or more processors of a computer system, and the one or more programs include instructions for: in accordance with a determination that a first set of criteria are satisfied, extending a first input mechanism from a first surface; and in accordance with a determination that a second set of criteria different from the first set of criteria are satisfied, forgoing extending the first input mechanism from the first surface.

In accordance with some embodiments, a computer system is described. The computer system comprises: one or more processors; and memory storing one or more programs configured to be executed by the one or more processors, the one or more programs including instructions for: in accordance with a determination that a first set of criteria are satisfied, extending a first input mechanism from a first surface; and in accordance with a determination that a second set of criteria different from the first set of criteria are satisfied, forgoing extending the first input mechanism from the first surface.

In accordance with some embodiments, a computer system is described. The computer system comprises: means for, in accordance with a determination that a first set of criteria are satisfied, extending a first input mechanism from a first surface; and means for, in accordance with a determination that a second set of criteria different from the first set of criteria are satisfied, forgoing extending the first input mechanism from the first surface.

In accordance with some embodiments, a computer program product is described. The computer program product comprises one or more programs configured to be executed by one or more processors of a computer system, the one or more programs including instructions for: in accordance with a determination that a first set of criteria are satisfied, extending a first input mechanism from a first surface; and in accordance with a determination that a second set of criteria different from the first set of criteria are satisfied, forgoing extending the first input mechanism from the first surface.

In some embodiments, executable instructions for performing these functions are included in a non-transitory computer-readable storage medium or other computer program product configured for execution by one or more processors. In some embodiments, executable instructions for performing these functions are included in a transitory computer-readable storage medium or other computer program product configured for execution by one or more processors.

### BRIEF DESCRIPTION OF THE FIGURES

To better understand the various described embodiments, reference should be made to the Description of Embodiments below, along with the following drawings in which like reference numerals refer to corresponding parts throughout the figures.

FIG. 1A illustrates an example system for implementing the techniques described herein.

FIG. 1B illustrates an example platform for implementing the techniques described herein.

FIGS. 2A-2J illustrate example techniques providing one or more input mechanisms, in accordance with some embodiments.

FIG. 3 is a flow diagram illustrating methods for modifying characteristics using one or more input mechanisms, in accordance with some embodiments.

FIG. 4 is a flow diagram illustrating methods for providing an input mechanism, in accordance with some embodiments.

FIGS. 5A-5G illustrate example techniques for modifying one or more mechanical properties of an input mechanism, in accordance with some embodiments.

FIG. 6 is a flow diagram illustrating methods for modifying one or more mechanical properties of an input mechanism, in accordance with some embodiments.

FIGS. 7A-7E illustrate example techniques for displaying content, in accordance with some embodiments.

FIG. 8 is a flow diagram illustrating methods for displaying content, in accordance with some embodiments.

### DESCRIPTION OF EMBODIMENTS

The following description sets forth exemplary methods, parameters, and the like. However, such description is not intended as a limitation on the scope of the present disclosure but is instead provided as a description of exemplary embodiments.

Although the following description uses terms “first,” “second,” etc. to describe various elements, these elements should not be limited by the terms. In some embodiments, these terms are used to distinguish one element from another. For example, a first item could be termed a second item, and, similarly, a second item could be termed a first item, without departing from the scope of the various described embodiments. In some embodiments, the first item and the second item are two separate references to the same item. In some embodiments, the first item and the second item are both the same type of item, but they are not the same item.

The terminology used in the description of the various described embodiments herein is for the purpose of describing particular embodiments only and is not intended to be limiting. The singular forms “a,” “an,” and “the” are intended to include the plural forms as well, unless the context clearly indicates otherwise. The term “and/or” refers to and encompasses any and all possible combinations of one or more of the associated listed items. The terms “includes,” “including,” “comprises,” and/or “comprising” specify the presence of stated features, steps, operations, elements, and/or components, but do not preclude the presence or addition of one or more other features, steps, operations, elements, components, and/or groups thereof.

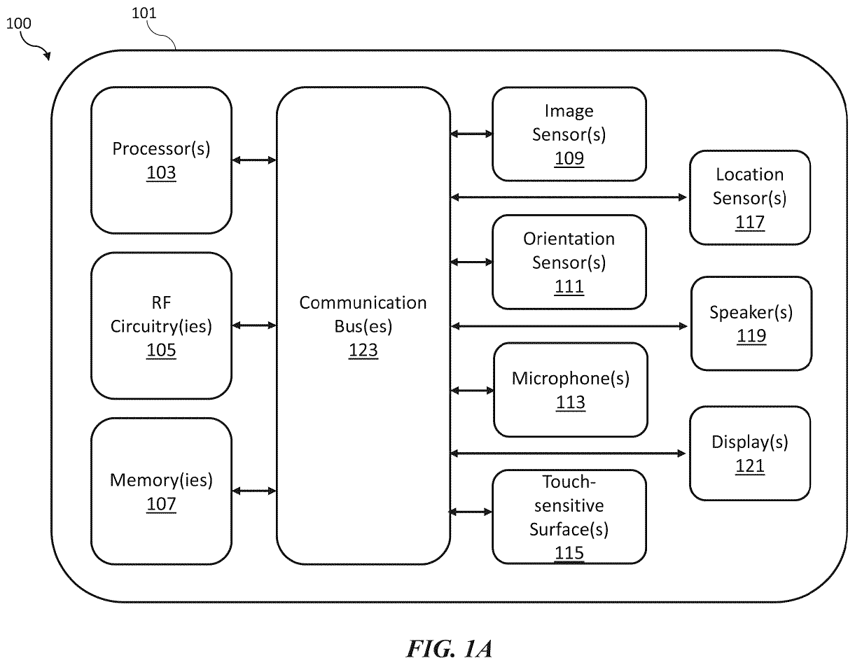

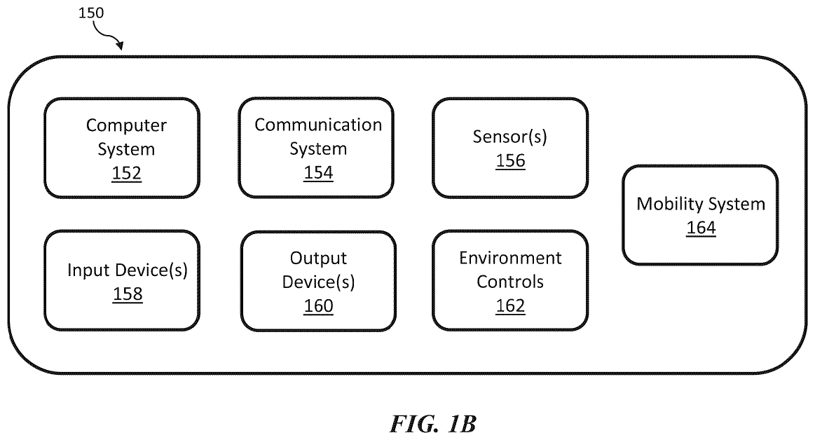

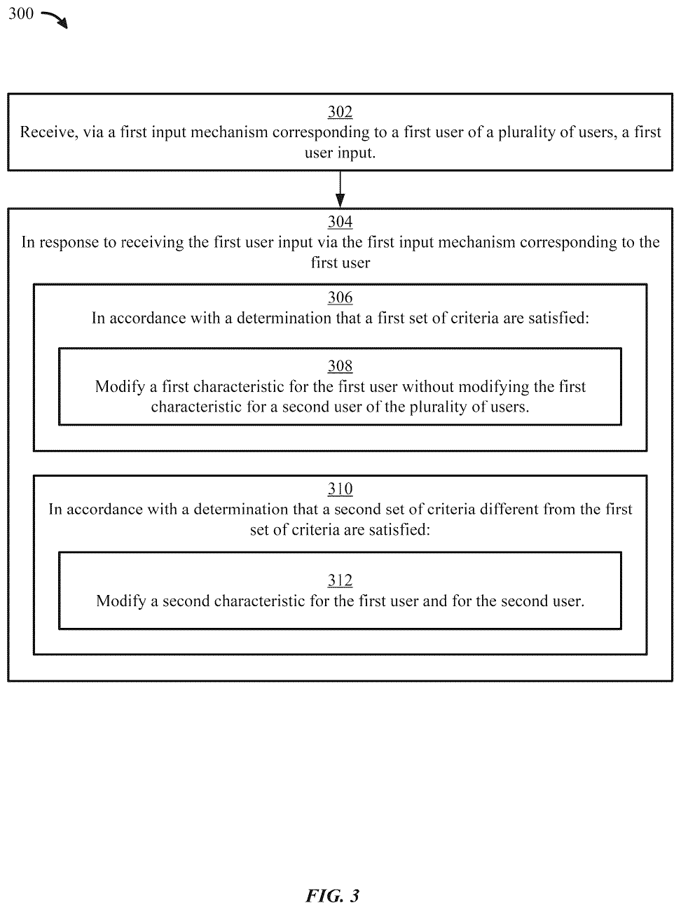

FIG. 1A illustrates an example system 100 for implementing the techniques described herein. System 100 can perform any of the methods described in FIGS. 3, 4, 6, and/or 8 (e.g., methods 300, 400, 600, and/or 800) or portions thereof.

In FIG. 1A, system 100 includes device 101. Device 101 includes various components, such as processor(s) 103, RF circuitry(ies) 105, memory(ies) 107, image sensor(s) 109, orientation sensor(s) 110, microphone(s) 113, location sensor(s) 117, speaker(s) 119, display(s) 121, and touch-sensitive surface(s) 115. These components optionally communicate over communication bus(es) 123 of device 101. In some embodiments, system 100 includes two or more devices that include some or all of the features of device 101.

In some embodiments, system 100 is a desktop computer, embedded computer, and/or a server. In some embodiments, system 100 is a mobile device such as, e.g., a smartphone, smartwatch, laptop computer, and/or tablet computer. In some embodiments, system 100 is a head-mounted display (HMD) device. In some embodiments, system 100 is a wearable HUD device.

System 100 includes processor(s) 103 and memory(ies) 107. Processor(s) 103 include one or more general processors, one or more graphics processors, and/or one or more digital signal processors. In some embodiments, memory(ies) 107 are one or more non-transitory computer-readable storage mediums (e.g., flash memory and/or random access memory) that store computer-readable instructions configured to be executed by processor(s) 103 to perform the techniques described herein.

System 100 includes RF circuitry(ies) 105. RF circuitry(ies) 105 optionally include circuitry for communicating with electronic devices, networks, such as the Internet, intranets, and/or a wireless network, such as cellular networks and wireless local area networks (LANs). RF circuitry(ies) 105 optionally includes circuitry for communicating using near-field communication and/or short-range communication, such as Bluetooth®.

System 100 includes display(s) 121. In some embodiments, display(s) 121 include one or more monitors, projectors, and/or screens. In some embodiments, display(s) 121 include a first display for displaying images to a first eye of the user and a second display for displaying images to a second eye of the user. Corresponding images are simultaneously displayed on the first display and the second display. Optionally, the corresponding images include the same virtual objects and/or representations of the same physical objects from different viewpoints, resulting in a parallax effect that provides a user with the illusion of depth of the objects on the displays. In some embodiments, display(s) 121 include a single display. Corresponding images are simultaneously displayed on a first area and a second area of the single display for each eye of the user. Optionally, the corresponding images include the same virtual objects and/or representations of the same physical objects from different viewpoints, resulting in a parallax effect that provides a user with the illusion of depth of the objects on the single display.

In some embodiments, system 100 includes touch-sensitive surface(s) 115 for receiving user inputs, such as tap inputs and swipe inputs. In some embodiments, display(s) 121 and touch-sensitive surface(s) 115 form touch-sensitive display(s).

System 100 includes image sensor(s) 109. Image sensor(s) 109 optionally include one or more visible light image sensor, such as charged coupled device (CCD) sensors, and/or complementary metal-oxide-semiconductor (CMOS) sensors operable to obtain images of physical objects. Image sensor(s) also optionally include one or more infrared (IR) sensor(s), such as a passive IR sensor or an active IR sensor, for detecting infrared light. For example, an active IR sensor includes an IR emitter, such as an IR dot emitter, for emitting infrared light. Image sensor(s) 109 also optionally include one or more camera(s) configured to capture movement of physical objects. Image sensor(s) 109 also optionally include one or more depth sensor(s) configured to detect the distance of physical objects from system 100. In some embodiments, system 100 uses CCD sensors, cameras, and depth sensors in combination to detect the physical environment around system 100. In some embodiments, image sensor(s) 109 include a first image sensor and a second image sensor. In some embodiments, system 100 uses image sensor(s) 109 to receive user inputs, such as hand gestures. In some embodiments, system 100 uses image sensor(s) 109 to detect the position and orientation of system 100 in the physical environment.

In some embodiments, system 100 includes microphones(s) 113. System 100 uses microphone(s) 113 to detect sound from the user and/or the physical environment of the user. In some embodiments, microphone(s) 113 includes an array of microphones (including a plurality of microphones) that optionally operate in tandem, such as to identify ambient noise or to locate the source of sound in space of the physical environment.

System 100 includes orientation sensor(s) 111 for detecting orientation and/or movement of system 100. For example, system 100 uses orientation sensor(s) 111 to track changes in the position and/or orientation of system 100, such as with respect to physical objects in the physical environment. Orientation sensor(s) 111 optionally include one or more gyroscopes, one or more inertial measurement units, and/or one or more accelerometers.

FIG. 1B illustrates an example platform in accordance with some embodiments. In some embodiments, the processes described with reference to FIGS. 3, 4, 6, and/or 8 are performed by or using platform 150.

Platform 150 includes computer system 152, communication system 154, sensor(s) 156, input device(s) 158, output device(s) 160, environment controls 162, and mobility system 164. In some embodiments, some of these elements are omitted from platform 150. In some embodiments, platform 150 includes additional elements.

In some embodiments, platform 150 is a mobile platform such as, e.g., a vehicle, car, bus, truck, train, bike, motorcycle, boat, plane, golf cart, and/or all-terrain vehicle (ATV), or other mobile vehicle. In some embodiments, platform 150 is semi-autonomous or completely autonomous (e.g., partially autonomous, conditionally autonomous, highly autonomous, or fully autonomous). In some embodiments, platform 150 is a home automation platform and/or a smart home platform that controls one or more functions and/or characteristics of a home, a house, and/or a building.

In some embodiments, platform 150 includes an interior portion (e.g., a cabin). In some embodiments, the interior portion is fully or partially enclosed and includes furniture such as, e.g., chairs, benches, tables, and/or armrests. In some embodiments, the furniture is configured to be controlled or actuated autonomously and/or manually (e.g., via computer system 152 and/or input device(s) 158).

In some embodiments, platform 150 includes one or more openings (e.g., doors) that are configured for a person to enter and/or exit (e.g., disembark) the interior portion of platform 150. In some embodiments, platform 150 includes one or more closures or apertures such as, e.g., a hood, trunk, window, and/or other opening that are configured to be opened and closed. In some embodiments, an opening is configured to be controlled or actuated autonomously and/or manually (e.g., via computer system 152 and/or input device(s) 158).

Computer system 152 includes one or more features of system 100 such as processor(s) 103 and/or memory(ies) 107. In some embodiments, computer system 152 is system 100 or device 101. In some embodiments, computer system 152 includes one or more processors (e.g., processor(s) 103) and memory (e.g., memory(ies) 107). In some embodiments, computer system 152 includes one or more general processors, one or more graphics processors, and/or one or more digital signal processors. In some embodiments, computer system 152 includes one or more non-transitory computer-readable storage mediums (e.g., transitory computer-readable storage mediums, non-transitory computer-readable storage mediums, flash memory, and/or random access memory) that store computer-readable instructions configured to be executed by the one or more processors to perform the techniques described herein.

Communication system 154 includes hardware (e.g., RF circuitry(ies) 105) and/or software that is configured to perform wireless and/or wired communication. In some embodiments, communication system 154 includes hardware and/or software for performing cellular communication, internet communication, near-field communication, Wi-Fi communication, short-range communication (e.g., Bluetooth communication), satellite communication, and/or other types of wireless communication.

Sensor(s) 156 include sensors for detecting various conditions. In some embodiments, sensor(s) 156 include orientation sensors (e.g., orientation sensor(s) 111) for detecting orientation and/or movement of platform 150. For example, platform 150 uses orientation sensors to track changes in the position and/or orientation of platform 150, such as with respect to physical objects in the physical environment. Sensor(s) 156 optionally include one or more gyroscopes, one or more inertial measurement units, and/or one or more accelerometers. Sensor(s) 156 include a global positioning sensor (GPS) for detecting a GPS location of platform 150. Sensor(s) 156 optionally include a radar system, LIDAR system, sonar system, image sensors (e.g., image sensor(s) 109, visible light image sensor(s), and/or infrared sensor(s)), depth sensor(s), rangefinder(s), and/or motion detector(s). Sensor(s) 156 optionally include sensors that are in an interior portion of platform 150 and/or sensors that are on an exterior of platform 150. In some embodiments, platform 150 uses sensor(s) 156 (e.g., interior sensors) to detect a presence and/or state (e.g., location and/or orientation) of a passenger in platform 150. In some embodiments, platform 150 uses sensor(s) 156 (e.g., external sensors) to detect a presence and/or state of an object external to platform 150. In some embodiments, platform 150 uses sensor(s) 156 to receive user inputs, such as hand gestures. In some embodiments, platform 150 uses sensor(s) 156 to detect the position and orientation of platform 150 in the physical environment. In some embodiments, platform 150 uses sensor(s) 156 to navigate platform 150 along a planned route, around obstacles, and/or to a destination location. In some embodiments, sensor(s) 156 include one or more sensors for identifying and/or authenticating a user of platform 150, such as a fingerprint sensor and/or facial recognition sensor.

Input device(s) 158 include one or more mechanical and/or electrical devices for detecting input such as, e.g., buttons, sliders, knobs, switches, remote controls, joysticks, touch-sensitive surfaces, keypads, microphones (e.g., microphone(s) 113), and/or cameras. In some embodiments, platform 150 uses microphones to detect sound from the user and/or the physical environment of the user. In some embodiments, platform 150 includes an array of microphones (including a plurality of microphones) that optionally operate in tandem, such as to identify ambient noise or to locate the source of sound in space (e.g., inside platform 150 and/or outside platform 150). In some embodiments, input device(s) 158 include one or more input devices inside platform 150. In some embodiments, input device(s) 158 include one or more input devices on an exterior of platform 150 (e.g., a touch-sensitive surface and/or keypad).

Output device(s) 160 include one or more devices such as, e.g., display(s), monitor(s), projector(s), speaker(s), light(s), and/or haptic output device(s). In some embodiments, output device(s) 160 include one or more external output devices such as external display screens, external lights, and/or external speakers. In some embodiments, output device(s) 160 include one or more internal output devices such as internal display screens, internal lights, and/or internal speakers

Environment controls 162 include mechanical and/or electrical systems for monitoring and/or controlling conditions of an internal portion (e.g., cabin) of platform 150. Environmental controls 162 optionally include fans, heater(s), air conditioner(s), and/or thermostat(s) for controlling the temperature and/or airflow within the interior portion of platform 150.

Mobility system 164 includes mechanical and/or electrical components that enable platform 150 to move and/or assist in the movement of platform 150. In some embodiments, mobility system 164 includes powertrain, a drivetrain, motor (e.g., an electrical motor), engine, power source (e.g., battery(ies)), transmission, suspension system, speed control system, and/or steering system. In some embodiments, one or more elements of mobility system 164 are configured to be controlled autonomously or manually (e.g., via computer system 152 and/or input device(s) 158).

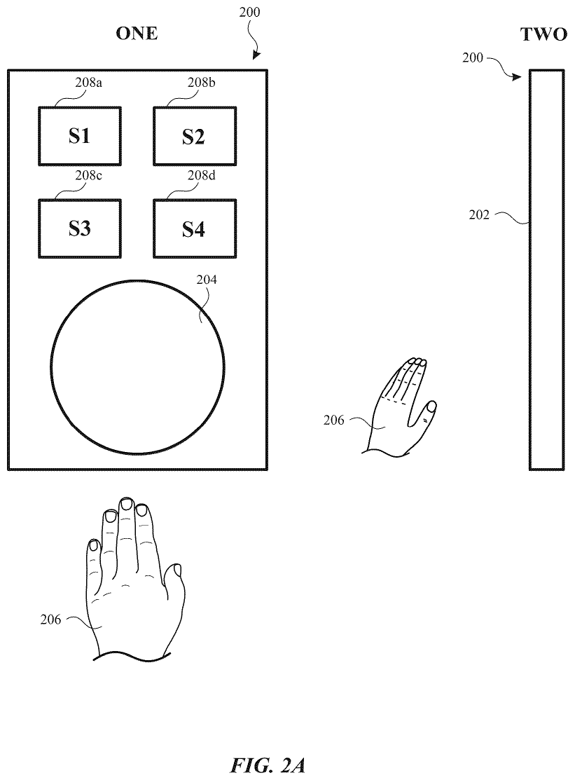

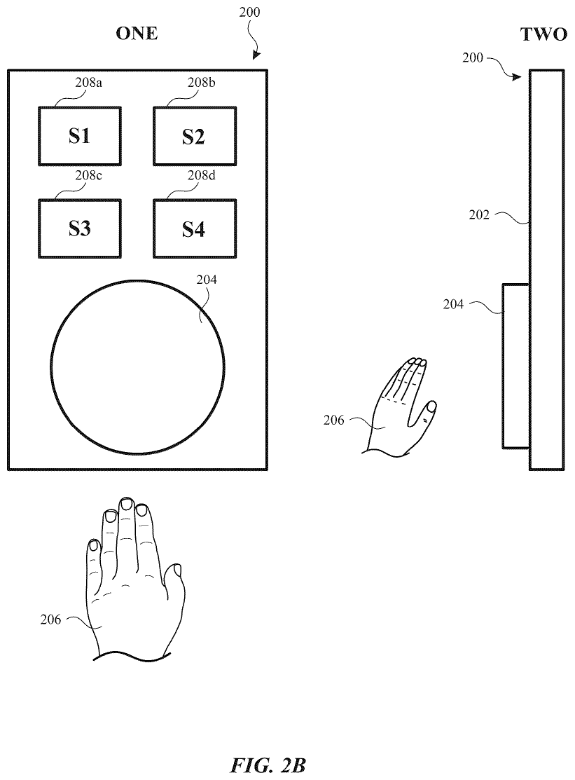

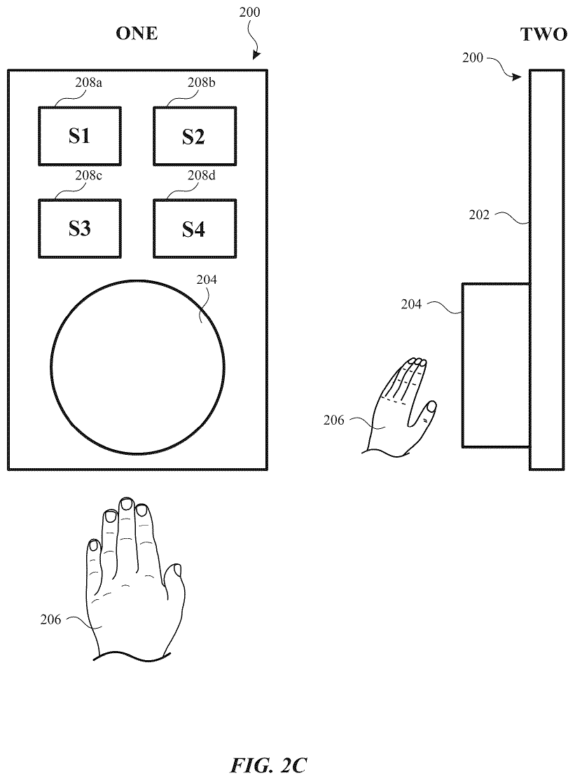

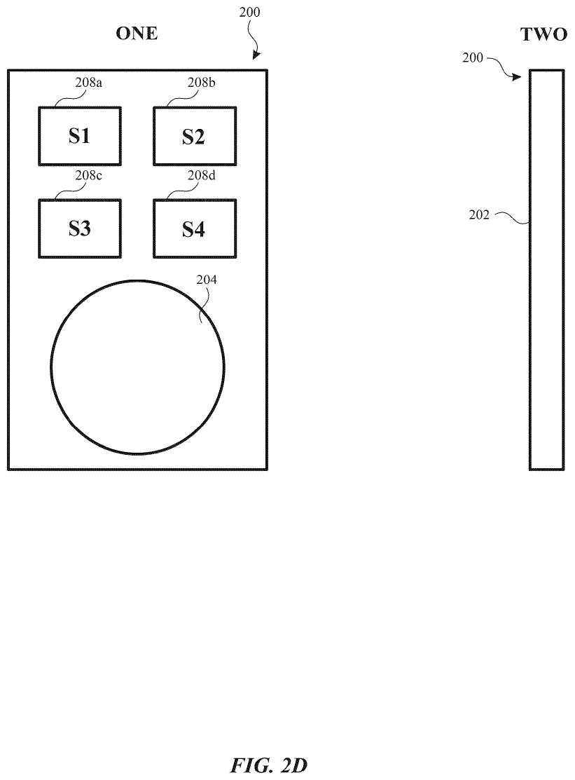

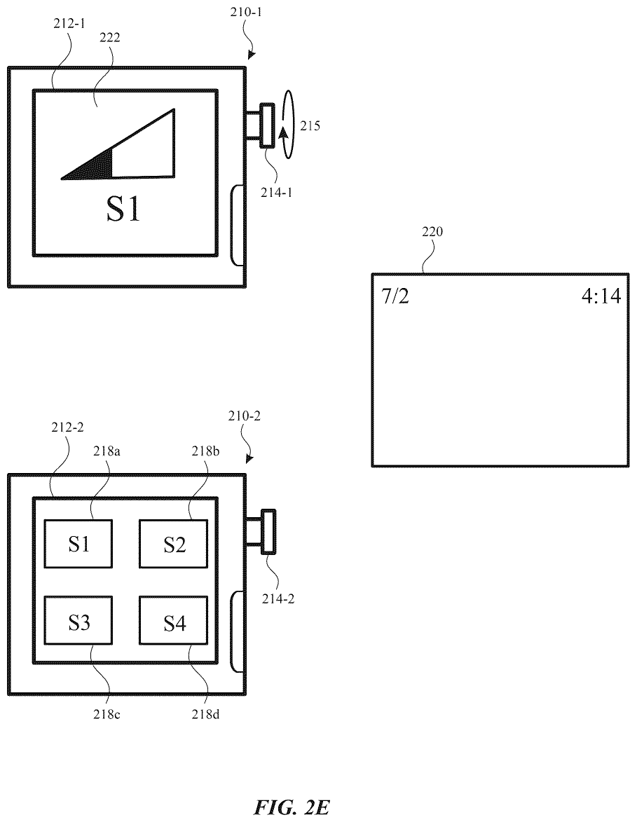

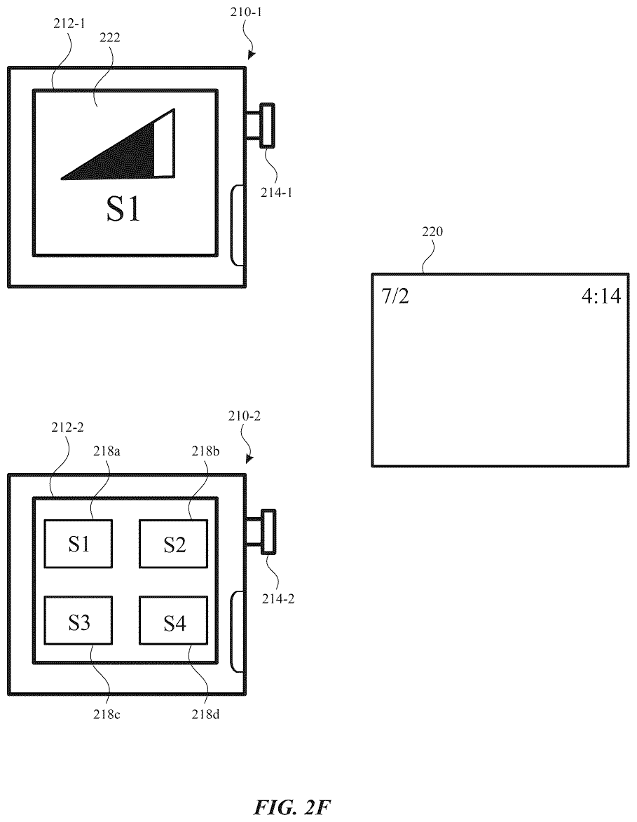

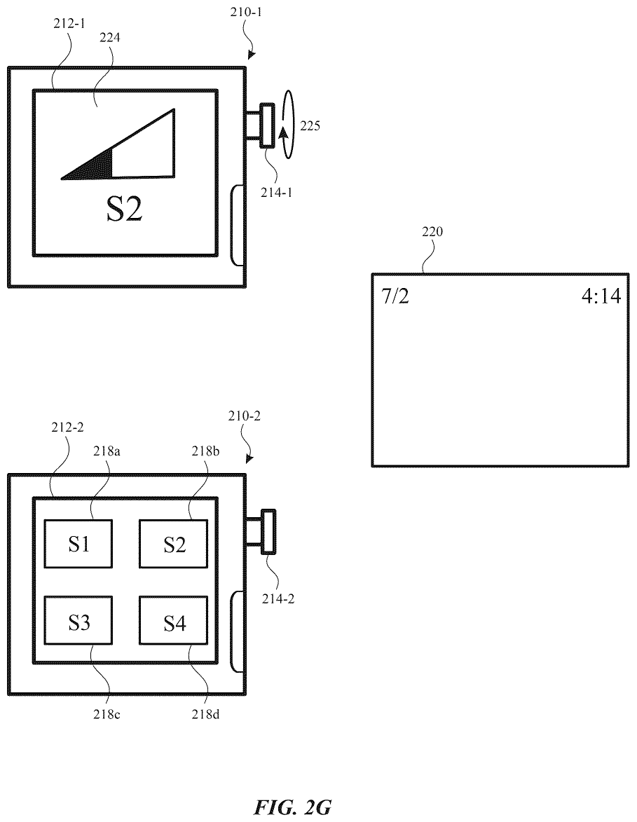

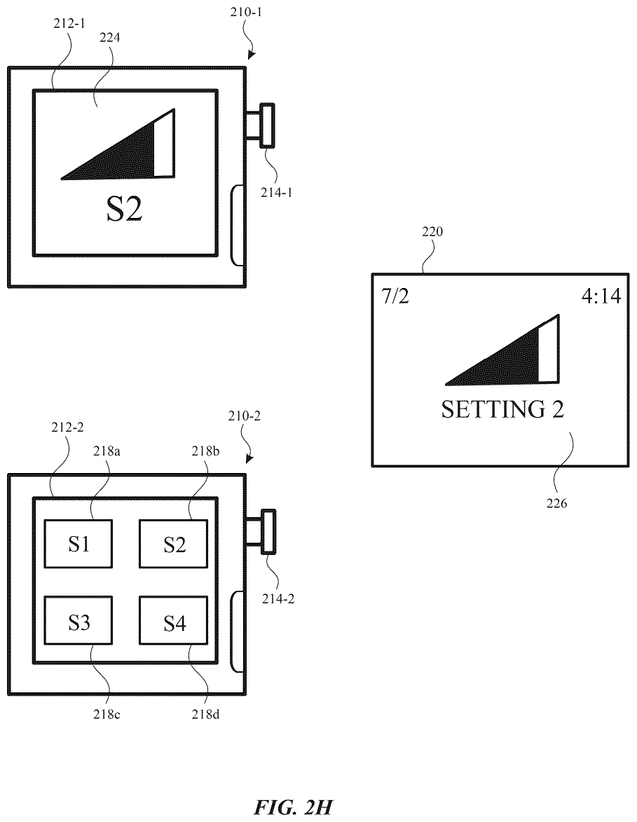

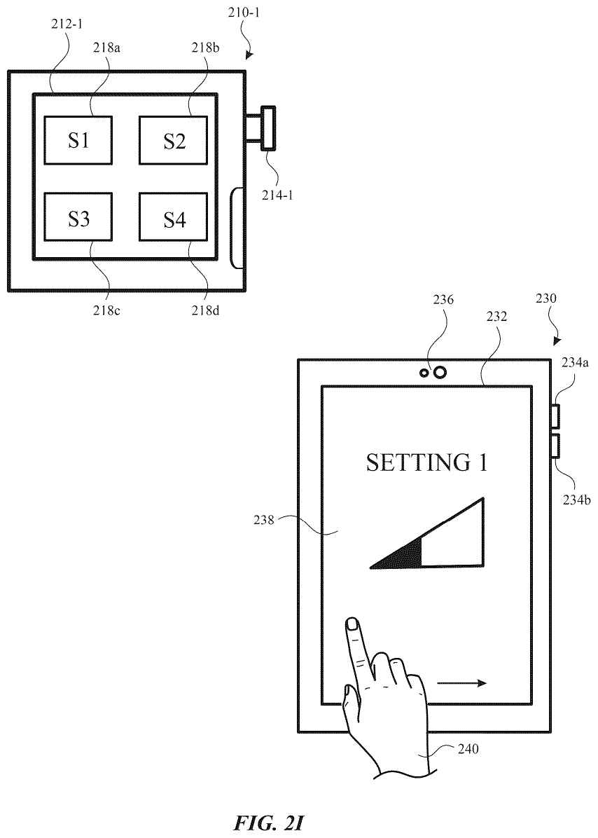

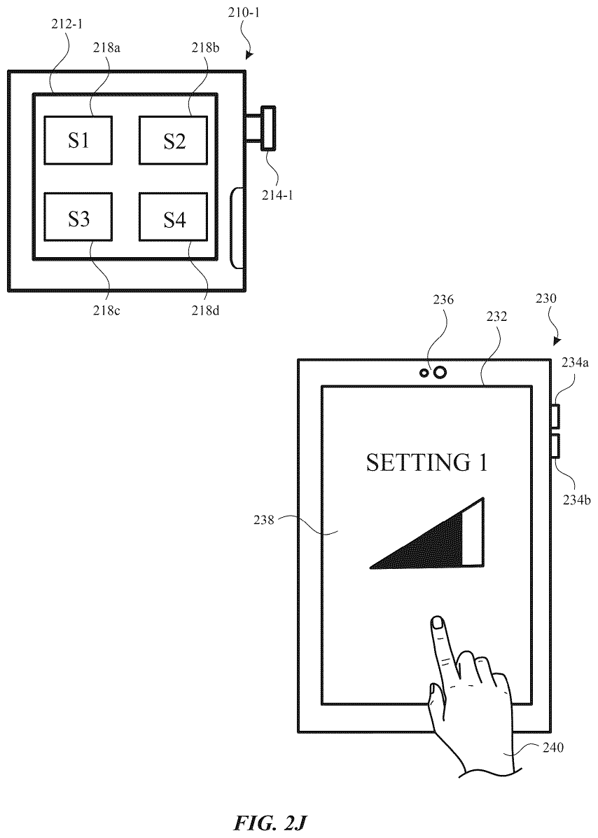

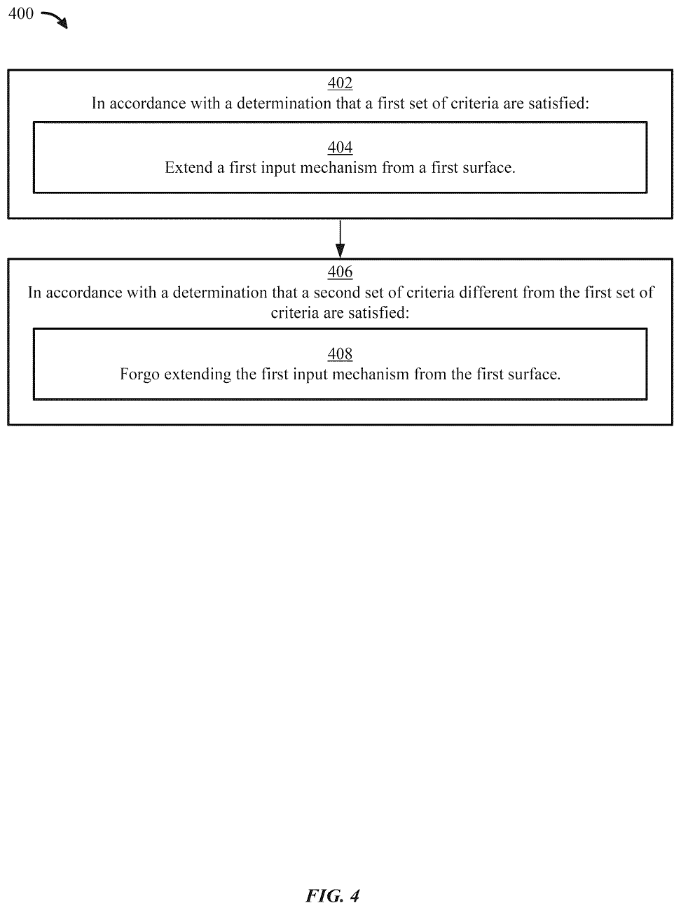

FIGS. 2A-2J illustrate example techniques for providing one or more input mechanisms, in accordance with some embodiments. FIG. 3 is a flow diagram of an exemplary method 300 for modifying characteristics using one or more input mechanisms, in accordance with some embodiments. FIG. 4 is a flow diagram of an exemplary method 400 for providing an input mechanism, in accordance with some embodiments. The example embodiments shown in FIGS. 2A-2J are used to illustrate the processes described below, including the processes in FIG. 3 and FIG. 4.

FIGS. 2A-2D depict input mechanism 200 in a front plan view (left, labeled “ONE”) and a side plan view (right, labeled “TWO”). Input mechanism 200 includes a touch-based input portion (e.g., a touch-based input mechanism) 202, and a mechanical input portion (e.g., a mechanical input mechanism) 204. Touch-based input portion 202 is a touch-sensitive display capable of receiving touch-based user inputs and displaying content. Mechanical input portion 204 is an extendable and retractable knob that is configured to receive rotational inputs (e.g., rotation of mechanical input portion 204) and depression inputs (e.g., depression and/or pressing of mechanical input portion 204). In FIG. 2A, touch-based input portion 202 displays graphical objects 208a-208d. Objects 208a-208d correspond to various settings and/or characteristics, and are selectable by a user in order to modify the selected setting using mechanical input portion 204. For example, in some embodiments, input mechanism 200 is part of a platform, such as a vehicle (e.g., an automobile), and objects 208a-208d correspond to a respective vehicle settings (e.g., temperature, volume, window opening, window tint, cabin light brightness, and the like). In some embodiments, the platform is a smart home platform and/or a home automation platform, input mechanism 200 controls one or more features and or functions of a home and/or building (e.g., objects 208a-208d correspond to respective home settings (e.g., temperature, volume, window opening, window tint, light brightness, and the like). A user is able to select an object 208a-208d to modify the corresponding setting (e.g., to modify temperature, modify volume, open or close a window, darken or brighten a window, darken or brighten a light) using mechanical input portion 204 (e.g., by rotating and/or pressing mechanical input portion 204). In this way, input mechanism 200 allows a user to modify a multitude of settings using a single input mechanism. In some embodiments, a platform such as a vehicle and/or a home includes multiple instances of input mechanism 200 (e.g., multiple input mechanisms 200 corresponding to respective seating positions within a vehicle cabin and/or multiple input mechanisms 200 in different rooms of a house). In some embodiments, a a vehicle includes multiple instances of input mechanism 200 and a particular instance of input mechanism 200 corresponds to a particular user (e.g., corresponds to a particular seating position within the vehicle cabin). Accordingly, in some embodiments, if a first input mechanism is used to modify a setting, the setting is modified for a first seating position and/or a first user corresponding to the first input mechanism, and if a second input mechanism is used to modify the setting, the setting is modified for a second seating position and/or a second user corresponding to the second input mechanism.

FIGS. 2A-2D also illustrate a retraction and deployment (e.g., extension) feature of mechanical input portion 204. In some embodiments, mechanical input portion 204 is movable between a plurality of deployment configurations. In FIG. 2A, mechanical input portion 204 is retracted into touch-based input portion 202, as can be seen in the side plan view. In this stowed configuration, mechanical input portion 204 lies flush and/or substantially flush with touch-based input portion 202. In some embodiments, in this stowed configuration, mechanical input portion 204 is not configured to receive rotational inputs. In some embodiments, in the stowed configuration, mechanical input portion 204 is not configured to receive any inputs (e.g., rotational or depression inputs). In some embodiments, in the stowed configuration, mechanical input portion 204 is able to receive depression inputs (e.g., a user is able to press mechanical input portion 204 like a button). In FIG. 2A, input mechanism 200 and/or a computer system (e.g., computer system 152) in communication with input mechanism 200 detects (e.g., via one or more cameras and/or one or more input sensors (e.g., 156 and/or 158)) a user's hand 206 moving towards input mechanism 200.

In FIG. 2B, in response to detecting the user's hand 206 moving towards input mechanism 200, input mechanism 200 and/or the computer system (e.g., 152) extend mechanical input portion 204 to a partially deployed configuration. FIG. 2C depicts an alternate scenario in which, in response to detecting the user's hand 206 moving towards input mechanism 200, input mechanism 200 and/or the computer system (e.g., 152) extend mechanical input portion 204 to a fully deployed configuration. In the fully deployed configuration, mechanical input portion 204 extends further out from touch-based input portion 202 than in the partially deployed configuration. In some embodiments, in the fully deployed configuration, mechanical input portion 204 is configured to receive rotational inputs. In some embodiments, in the fully deployed configuration, mechanical input portion 204 is also configured to receive depression inputs. In some embodiments, in the partially deployed configuration, mechanical input portion 204 is not configured to receive rotational inputs (e.g., mechanical input portion 204 does not rotate when in the partially deployed configuration and/or does not respond to and/or register rotational inputs), but is configured to receive depression inputs. In some embodiments, mechanical input portion 204 extends to the partially deployed configuration in certain conditions (e.g., when certain conditions are detected), and extends to the fully deployed configuration in other conditions (e.g., when other conditions are detected). For example, in some embodiments, mechanical input portion 204 does not extend to the fully deployed configuration (e.g., only extends to the partially deployed configuration) when a vehicle (e.g., a vehicle that includes input mechanism 200) is not moving and/or is not in transit, but does extend to the fully deployed configuration when the vehicle is moving and/or when the vehicle is in transit.

At FIG. 2D, input mechanism 200 (and/or a computer system in communication with input mechanism 200) detects that the hand of the user is no longer near input mechanism 200 and/or is no longer interacting with input mechanism 200 (e.g., has finished interacting with input mechanism 200). In response to this determination, mechanical input portion 204 is retracted back into touch-based input portion 202.

FIG. 2E depicts electronic device 210-1, electronic device 210-2, and display 220. In FIG. 2E, electronic device 210-1 is a smart watch with touch-sensitive display 212-1 and rotatable and depressible input mechanism 214-1. In FIG. 2E, electronic device 210-2 is also a smart watch with touch-sensitive display 212-2 and rotatable and depressible input mechanism 214-2. In some embodiments, electronic device 210-1, electronic device 210-2, and display 220 are part of a platform (e.g., platform 150, vehicle platform (e.g., a vehicle system, a vehicle, and/or an automobile), a smart home platform, and/or a home automation platform). In some embodiments, electronic devices 210-1, 210-2 are input mechanisms for a platform, similar to input mechanism 200 discussed above (e.g., in some embodiments, electronic devices 210-1, 210-2 are affixed (e.g., permanently affixed) to the interior cabin of a vehicle and are used to modify one or more settings of the vehicle) (e.g., in some embodiments, electronic devices 210-1, 210-2 are affixed (e.g., permanently affixed) to the interior of a home and are used to modify one or more settings of the home). In some embodiments, electronic device 210-1 corresponds to a first user (e.g., a first user seated in a vehicle, a first seating position in a vehicle, and/or a first user in a home), and allows the first user to modify one or more settings (e.g., one or more vehicle settings and/or one or more home settings), and electronic device 210-2 corresponds to a second user (e.g., a second user seated in a vehicle and/or a second user in a home), and allows the second user to modify one or more settings (e.g., one or more vehicle settings and/or one or more home settings). In some embodiments, display 220 is a shared display that is shared by and/or visible to multiple users (e.g., a display in a vehicle cabin that is visible to some or all riders in the vehicle cabin and/or a display in a home that is visible to some or all occupants of the home). In some embodiments described below, electronic devices 210-1, 210-2 are smart watches, as depicted in FIGS. 2E-2J. In other embodiments, electronic devices 210-1, 210-2 are input mechanisms that have the same form and function as input mechanism 200 described above, and have a touch-based input portion 202 (e.g., touch-screen displays 212-1, 212-2) and a mechanical input portion 204 (e.g., rotatable and depressible input mechanisms 214-1, 214-2), wherein the mechanical input portion 204 is movable between a plurality of deployment configurations, as discussed above with reference to FIGS. 2A-2D. In various embodiments described herein, any features and/or functions described with reference to electronic devices 210-1, 210-2 are also attributable to input mechanism 200; any features and/or functions described with reference to touch-sensitive displays 212-1, 212-2 are also attributable to touch-based input portion 202; and any features and/or functions described with reference to rotatable and depressible input mechanisms 214-1, 214-2 are also attributable to mechanical input portion 204.

At FIG. 2E, electronic device 210-1 displays a user interface that includes selectable objects 218a-218d corresponding to four different settings (similar to objects 208a-208d described above with reference to FIGS. 2A-2D). In some embodiments, objects 218a-218d are selectable in order to modify a corresponding setting using rotatable and depressible input mechanism 214-2 (similar to input mechanism 200, described above with reference to FIGS. 2A-2D). Electronic device 210-1 displays, via touch-sensitive display 212-1, user interface 222 corresponding to a first setting (e.g., setting one). In some embodiments, electronic device 210-1 displays user interface 222 in response to a selection input by a user selecting the first setting (e.g., electronic device 210-1 previously displayed objects 218a-218d, and a user selected object 218a (e.g., using a touch input) on electronic device 210-1). As described above, in some embodiments, electronic device 210-1 is not a smart watch, but is input mechanism 200 of FIGS. 2A-2D. In some such embodiments, in response to a user input selecting a particular setting to be modified, touch-sensitive display 202 displays a user interface around mechanical input portion 204 that corresponds to the selected setting. For example, if a user selects object 208a in FIG. 2D, touch-sensitive display 202 displays a first user interface corresponding to the first setting, and if a user selects object 208b in FIG. 2D, touch-sensitive display 202 displays a second user interface different from the first user interface and corresponding to the second setting. At FIG. 2E, electronic device 210-1 detects user input 215, which is a rotation of rotatable and depressible input mechanism 214-1.

At FIG. 2F, in response to user input 215, electronic device 210-1 displays, in user interface 222, an indication that the user has changed the first setting. In some embodiments, the first setting is an individual setting that applies only to the first user (e.g., an individual climate setting). Accordingly, in response to user input 215, only electronic device 210-1 displays an indication that the first setting was changed. FIGS. 2G-2H illustrate a second example scenario, in which a user changes a setting that applies to multiple users (e.g., all users and/or multiple users in a vehicle cabin and/or all users and/or multiple users in a home).

At FIG. 2G, electronic device 210-1 displays user interface 224 corresponding to a second setting (e.g., in response to a user input selecting the second setting (e.g., selection of object 218b when it was previously displayed on electronic device 210-1)). In FIG. 2G, while displaying user interface 224 (e.g., while the second setting is selected for modification), electronic device 210-1 detects user input 225, which is a rotation of rotatable and depressible input mechanism 214-1.

At FIG. 2H, in response to user input 225, electronic device 210-1 displays an indication that the second setting has been changed. However, in response to user input 225, and based on a determination that the second setting is a setting that applies to a plurality of users (and not just the first user), display 220 also displays indication 226 indicating that the second setting has been changed. In some embodiments, indication 226 is overlaid on top of content that was previously being display on display 220 (e.g., a video that was being played on display 220).

FIGS. 21-2J depict an example scenario in which a user uses a personal device (such as a smart phone or tablet) to modify one or more settings (e.g., to modify one or more vehicle settings and/or one or more home settings). At FIG. 2I, electronic device 210-1, which corresponds to a first user (e.g., a first user in a vehicle, a first seating position in a vehicle, and/or a first user in a home), displays objects 218a-218d corresponding to four different settings. FIG. 2I also depicts electronic device 230, which is a smart phone that corresponds to the first user, and includes touch-sensitive display 232, buttons 234a-234b, and input sensors 236. At FIG. 2I, electronic device 230 displays user interface 238, which corresponds to the first setting (which, in some embodiments, also corresponds to object 218a displayed on electronic device 210-1), and detects user input 240 (e.g., a touch input and/or a swipe input). At FIG. 2J, in response to user input 240, electronic device 230 displays an indication (in user interface 238) that the first setting has been changed. Furthermore, based on both electronic device 230 and electronic device 210-1 corresponding to the same user, electronic device 210-1 also displays an indication 222 that the first setting has been changed. As discussed above, in some embodiments, electronic device 210-1 is input mechanism 200. Furthermore, as also discussed above, in some embodiments, electronic device 210-1 and/or input mechanism 200 are part of a platform, such as a vehicle and/or a home automation platform. In some embodiments, electronic device 210-1 and/or input mechanism 200 are affixed (e.g., permanently) within an interior cabin of a vehicle (e.g., in some embodiments, the vehicle includes multiple input mechanisms corresponding to the different seats and/or users in the vehicle), whereas electronic device 230 is a portable device belonging to a user and is not secured and/or affixed to a vehicle. Accordingly, the depicted embodiments demonstrate scenarios in which a user is able to use a single input mechanism that is part of a vehicle to change multiple vehicle settings, either for the user individually or for multiple users in the vehicle, and a user is also able to use his or her personal mobile device (e.g., smart phone, tablet, and/or wearable device (e.g., watch)) to modify a plurality of vehicle settings.

Additional descriptions regarding FIGS. 2A-2J are provided below in reference to method 300 described with respect to FIG. 3 and method 400 described with respect to FIG. 4.

FIG. 3 is a flow diagram of an exemplary method 300 for modifying characteristics using one or more input mechanisms, in accordance with some embodiments. In some embodiments method 500 is performed at a computer system (e.g., computer system 152) and/or a platform (e.g., platform 150). In some embodiments, method 300 is governed by instructions that are stored in a non-transitory (or transitory) computer-readable storage medium and that are executed by one or more processors of a computer system or platform, such as the one or more processors 103 of system 100. Some operations in method 300 are, optionally, combined and/or the order of some operations is, optionally, changed.

In some embodiments, a computer system (e.g., 152) receives (302), via a first input mechanism (e.g., 200, 210-1, and/or 210-2) (e.g., a physical input mechanism, a touch-sensitive surface, a touch-sensitive display, a button, a rotatable input mechanism, and/or a rotatable and depressible input mechanism) (e.g., a first input mechanism in communication with a computer system (e.g., a smart phone, a smart watch, a tablet, a wearable device, a head-mounted device, and/or a computer system that is part of a platform such as a vehicle system (e.g., a computer system that is built into a vehicle system and/or controls one or more functions of a vehicle (e.g., an automobile))); a first input mechanism that is part of a platform such as, e.g., a vehicle; and/or a first input mechanism configured to receive input from a user) (e.g., a touch-sensitive surface (e.g., a touch-sensitive display); a mouse; a keyboard; a remote control; a visual input device (e.g., one or more cameras (e.g., an infrared camera, a depth camera, a visible light camera)); an audio input device; a mechanical input device (e.g., a button, a dial, a rotatable input mechanism, and/or a depressible input mechanism) and/or a biometric sensor (e.g., a fingerprint sensor, a face identification sensor, and/or an iris identification sensor)) corresponding to a first user (e.g., corresponding exclusively to the first user, corresponding to a first seating position of a plurality of seating positions (e.g., a first seating position of a plurality of seating positions in a vehicle cabin), and/or corresponding to a first region within a three-dimensional space (e.g., a first region within a vehicle cabin)) of a plurality of users (e.g., a plurality of users in different seating positions, a plurality of users in a room and/or space, and/or a plurality of users in a vehicle cabin), a first user input (e.g., 215 and/or 225) (e.g., a touch input and/or a physical control input (e.g., rotation of a rotatable input mechanism and/or depression of a depressible input mechanism)). In response to receiving the first user input via the first input mechanism (e.g., 200, 210-1, and/or 210-2) corresponding to the first user (304): in accordance with a determination that a first set of criteria are satisfied (306), the computer system modifies (308) a first characteristic (e.g., a first setting and/or a first vehicle setting) (e.g., audio volume, window tinting, window height (e.g., window open and/or close), display brightness, cabin brightness, temperature, air output intensity, seat incline, and/or seat height) for the first user without modifying the first characteristic for a second user of the plurality of users (e.g., FIGS. 2E-2F, setting 1 is modified for only the first user and not other users) (e.g., modifies the first characteristics for only the first user without modifying the first characteristic for any other user of the plurality of users); and in accordance with a determination that a second set of criteria different from the first set of criteria are satisfied (310), the computer system modifies (312) a second characteristic (e.g., a second characteristic that is the same as or different from the first characteristic) (e.g., a second setting and/or a second vehicle setting) (e.g., audio volume, window tinting, window height (e.g., window open and/or close), display brightness, cabin brightness, temperature, air output intensity, seat incline, and/or seat height) for the first user and for the second user (e.g., FIGS. 2G-2H, setting 2 is modified for multiple users, as indicated by user interface 226 on display 220) (e.g., modifies the second characteristic for a plurality of users, modifies the second characteristic for the plurality of users, modifying the second characteristic for all users in a vehicle cabin and/or modifies the second characteristic for the vehicle cabin). In some embodiments, the first set of criteria includes a criterion that is satisfied when the first input mechanism is configured to modify the first characteristic (e.g., at the time of receiving the first user input) (e.g., a user has selected, for the first input mechanism, the first characteristic of a plurality of characteristics and/or the first characteristic has been automatically selected (e.g., by a computer system and/or device) from the plurality of characteristics based on one or more selection criteria). In some embodiments, the second set of criteria includes a criterion that is satisfied when the first input mechanism is configured to modify the second characteristic (e.g., at the time of receiving the first user input) (e.g., a user has selected, for the first input mechanism, the second characteristic of a plurality of characteristics and/or the second characteristic has been automatically selected (e.g., by a computer system and/or device) from the plurality of characteristics based on one or more selection criteria). Providing an input mechanism that can be used to modify a first characteristic for a first user or modify a second characteristic for multiple users enhances the operability of the system and makes the user-system interface more efficient by reducing the number of controls and/or input mechanisms required to perform various operations.

In some embodiments, the first input mechanism (e.g., 200, 210-1, and/or 210-2) comprises a first extendible component (e.g., 204, 214-1, and/or 214-2) that is movable between a plurality of configurations, including a stowed configuration (e.g., 204 in FIG. 2A) (e.g., a configuration in which the first extendible component is retracted to lie flush and/or substantially flush with a surface, an enclosure, and/or a housing; and/or a configuration in which the first extendible component is retracted and/or less extended relative to one or more deployed configurations) and a first deployed configuration (e.g., 204 in FIGS. 2B and/or 2C) (e.g., a configuration in which the first extendible component extends from a surface, an enclosure, and/or a housing; and/or a configuration in which the first extendible component is more extended than when the first extendible component is in the stowed configuration) different from the stowed configuration. In some embodiments, while the first extendible component (e.g., 204, 214-1, and/or 214-2) of the first input mechanism (e.g., 200, 210-1, and/or 210-2) is in the stowed configuration (e.g., 204 in FIG. 2A): in accordance with a determination that a set of extension criteria are satisfied (e.g., detecting movement of a user's hand towards the first input mechanism; detecting one or more user inputs; detecting one or more user gestures; detecting one or more gaze inputs (e.g., detecting that the user is looking at the first input mechanism); and/or detecting that a platform, such as, e.g., a vehicle, is in a first state (e.g., departing from a location; stopped; moving; and/or arriving at a location)), the computer system (e.g., 152) moves the first extendible component from the stowed configuration (e.g., 204 in FIG. 2A) to the first deployed configuration (e.g., 204 in FIGS. 2B and/or 2C) (e.g., moving at least a portion of the first extendible component away from a surface, an enclosure, and/or a housing). Automatically extending the first extendible component when the set of extension criteria are satisfied allows for this operation to be performed without user input, thereby reducing the number of user inputs required to perform an operation. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently. Doing so also provides the user with visual feedback about the state of the system (e.g., the system has determined that the set of extension criteria are satisfied), thereby providing improved visual feedback to the user.

In some embodiments, the plurality of configurations further includes a second deployed configuration (e.g., 204 in FIG. 2B and/or FIG. 2C) (e.g., a configuration in which the first extendible component extends from a surface, an enclosure, and/or a housing; and/or a configuration in which the first extendible component is more extended than when the first extendible component is in the stowed configuration but less extended than when the first extendible component is in the first deployed configuration) different from the first deployed configuration and the stowed configuration. In some embodiments, while the first extendible component (e.g., 204, 214-1, and/or 214-2) of the first input mechanism (e.g., 200, 210-1, and/or 210-2) is in the stowed configuration (e.g., 204 in FIG. 2A): in accordance with a determination that a second set of extension criteria are satisfied (e.g., a second set of extension criteria different from the set of extension criteria) (e.g., detecting movement of a user's hand towards the first input mechanism; detecting one or more user inputs; detecting one or more user gestures; detecting one or more gaze inputs (e.g., detecting that the user is looking at the first input mechanism); and/or detecting that a platform, such as, e.g., a vehicle, is in a first state (e.g., departing from a location; stopped; moving; and/or arriving at a location)), the computer system (e.g., 152) moves the first extendible component (e.g., 204, 214-1, and/or 214-2) from the stowed configuration (e.g., 204 in FIG. 2A) to the second deployed configuration (e.g., 204 in FIGS. 2B and/or 2C) (e.g., moving at least a portion of the first extendible component away from a surface, an enclosure, and/or a housing). In some embodiments, in the first deployed configuration (e.g., FIG. 2C), the first extendible component (e.g., 204, 214-1, and/or 214-2) is rotatable (e.g., configured to rotate and/or configured to receive user rotation inputs) (and, optionally, in some embodiments, is also depressible (e.g., configured to be pressed and/or configured to receive user press inputs and/or depression inputs); and in the second deployed configuration (e.g., FIG. 2B), the first extendible component is not rotatable (e.g., is not configured to rotate and/or is not configured to receive user rotation inputs). In some embodiments, in the second deployed configuration (e.g., FIG. 2B), the first extendible component is depressible (e.g., configured to be pressed and/or configured to receive user press inputs and/or depression inputs). Automatically extending the first extendible component to the first deployed configuration or the second display configuration when extension criteria are satisfied allows for these operations to be performed without user input, thereby reducing the number of user inputs required to perform an operation. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently. Doing so also provides the user with visual feedback about the state of the system (e.g., the system has determined that the set of extension criteria are satisfied), thereby providing improved visual feedback to the user.

In some embodiments, the first input mechanism (e.g., 200, 210-1, and/or 210-2) comprises: a touch-sensitive input portion (e.g., 202, 212-1, and/or 212-2) (e.g., a touch-sensitive surface and/or a touch-sensitive display) configured to receive touch-based user inputs; and a mechanical input portion (e.g., 204, 214-1, and/or 214-2) configured to receive mechanical user inputs (e.g., rotation and/or depression of the mechanical input portion) (e.g., user inputs that cause physical movement of the mechanical input portion). In some embodiments, the computer system (e.g., 152) receives, via the touch-sensitive input portion (e.g., 202, 212-1, and/or 212-2), a selection input (e.g., one or more touch inputs) corresponding to selection of a first setting (e.g., 208a-208d and/or 218a-218d) of a plurality of settings (e.g., 208a-208d and/or 218a-218d) (e.g., a plurality of vehicle settings). In some embodiments, in response to receiving the selection input, the computer system displays, via a display generation component (e.g., 202, 212-1, and/or 212-2) (e.g., a display generation component of the first input mechanism), an indication that the first setting has been selected (e.g., user interface 222 and/or user interface 224). Subsequent to receiving the selection input (e.g., while the first setting is selected), the computer system receives, via the mechanical input portion, a modification input (e.g., 215, 225, and/or rotation of 204, 214-1, and/or 214-2) (e.g., one or more rotations and/or one or more depressions of the mechanical input portion). In response to receiving the modification input, the computer system modifies the first setting (e.g., changing the first setting from a first value to a second value) (e.g., FIGS. 2E-2F). Providing an input mechanism that can be used to modify a first characteristic for a first user or modify a second characteristic for multiple users via a touch-sensitive input portion and/or a mechanical input portion enhances the operability of the system and makes the user-system interface more efficient by reducing the number of controls and/or input mechanisms required to perform various operations.

In some embodiments, in response to receiving the first user input (e.g., 215 and/or 225) via the first input mechanism (e.g., 204, 214-1, and/or 214-2): in accordance with a determination that the first set of criteria are satisfied, the computer system (e.g., 152) displays, via a first display generation component (e.g., 202, 212-1, and/or 212-2) corresponding to the first input mechanism (e.g., 200, 210-1, and/or 210-2) (e.g., a first display generation component that is part of the first input mechanism and/or a first display generation component that is in communication with the first input mechanism), an indication that the first characteristic was modified (e.g., 222 in FIGS. 2E-2F) (and, in some embodiments, without displaying the indication that the first characteristic was modified and/or any indication that that the first characteristic was modified on the second display generation component); and in accordance with a determination that the second set of criteria are satisfied, the computer system displays, via a second display generation component (e.g., 220) different from the first display generation component (e.g., a second display generation component that does not correspond to the first input mechanism; a second display generation component that is not a part of and/or is not built into the first input mechanism; a second display generation component corresponding to the plurality of users; a shared display generation component; and/or a central display generation component), an indication that the second characteristic was modified (e.g., 226 in FIGS. 2G-2H) (and, in some embodiments, displays (e.g., concurrently displays), via the first display generation component (e.g., 202, 212-1, and/or 212-2), a second indication that the second characteristic was modified (e.g., 224 in FIGS. 2G-2H)). Providing an input mechanism that can be used to modify a first characteristic for a first user or modify a second characteristic for multiple users enhances the operability of the system and makes the user-system interface more efficient by reducing the number of controls and/or input mechanisms required to perform various operations. Furthermore, displaying an indication on the first input mechanism and/or on a shared display indicating a change in a setting provides the user with visual feedback about the state of the system (e.g., that the setting was changed), thereby providing improved visual feedback to the user.

In some embodiments, displaying the indication that the second characteristic was modified (e.g., 226) on the second display generation component (e.g., 220) comprises overlaying the indication that the second characteristic was modified (e.g., 226) on content that was previously displayed on the second display generation component (e.g., overlaying user interface 226 on other content that was previously displayed on display 220). Providing an input mechanism that can be used to modify a first characteristic for a first user or modify a second characteristic for multiple users enhances the operability of the system and makes the user-system interface more efficient by reducing the number of controls and/or input mechanisms required to perform various operations. Furthermore, displaying an indication on the first input mechanism and/or on a shared display indicating a change in a setting provides the user with visual feedback about the state of the system (e.g., that the setting was changed), thereby providing improved visual feedback to the user.

In some embodiments, the computer system (e.g., 152) displays, via the second display generation component (e.g., 220), first content (e.g., a first video and/or first visual content) (e.g., a user-selected video plays on display 220); and modifies visual content displayed on the first display generation component (e.g., 202, 212-1, and/or 212-2) based on the first content (e.g., displaying one or more quick control options corresponding to the first content) (e.g., the computer system displays on display 212-1 quick access controls or other content pertaining to the video content playing on display 220). Automatically changing content that is displayed on the first display generation component based on content that is displayed on the second display generation component allows for performance of these operations without further user input, thereby reducing the number of user inputs required to perform an operation.

In some embodiments, the computer system (e.g., 152) receives, via the first input mechanism (e.g., 200, 210-1, and/or 210-2) corresponding to the first user, a second user input (e.g., 225) (e.g., a touch input and/or a physical control input (e.g., rotation of a rotatable input mechanism and/or depression of a depressible input mechanism)), wherein the second user input corresponds to a request by the first user to modify the second characteristic; and receives, concurrently with the second user input, via a second input mechanism (e.g., 200, 210-1, and/or 210-2) (e.g., a physical input mechanism, a touch-sensitive surface, a touch-sensitive display, a button, a rotatable input mechanism, and/or a rotatable and depressible input mechanism) (e.g., an input mechanism in communication with a computer system (e.g., a smart phone, a smart watch, a tablet, a wearable device, a head-mounted device, and/or a computer system that is part of a platform such as a vehicle system (e.g., a computer system that is built into a vehicle system and/or controls one or more functions of a vehicle (e.g., an automobile))); an input mechanism that is part of a platform such as, e.g., a vehicle; and/or an input mechanism configured to receive input from a user) (e.g., a touch-sensitive surface (e.g., a touch-sensitive display); a mouse; a keyboard; a remote control; a visual input device (e.g., one or more cameras (e.g., an infrared camera, a depth camera, a visible light camera)); an audio input device; a mechanical input device (e.g., a button, a dial, a rotatable input mechanism, and/or a depressible input mechanism) and/or a biometric sensor (e.g., a fingerprint sensor, a face identification sensor, and/or an iris identification sensor)) different from the first input mechanism and corresponding to a second user (e.g., corresponding exclusively to the second user, corresponding to a second seating position of a plurality of seating positions (e.g., a second seating position of a plurality of seating positions in a vehicle cabin), and/or corresponding to a second region within a three-dimensional space (e.g., a second region within a vehicle cabin)) different from the first user, a third user input (e.g., a touch input and/or a physical control input (e.g., rotation of a rotatable input mechanism and/or depression of a depressible input mechanism)), wherein the third user input corresponds to a request by the second user to modify the second characteristic (e.g., the computer system detects concurrent rotation of rotatable input mechanism 214-1 by a first user and rotation of rotatable input mechanism 214-2 by a second user in FIG. 2G). In response to concurrently receiving the second user input via the first input mechanism and the third user input via the second input mechanism: in accordance with a determination that the first user is identified as a first type of user (e.g., a user that has higher authorization and/or higher priority than the second user) (and, in some embodiments, in accordance with a determination that the second user is not identified as the first type of user): the computer system modifies the second characteristic based on the second user input (e.g., 225) without modifying the second characteristic based on the third user input (e.g., ignoring the third user input) (e.g., modifying the second characteristic based on the rotation of mechanism 214-1 and ignoring the rotation of mechanism 214-2). Automatically selecting which user input to respond to based on the identifies of the users providing concurrent user inputs enhances the operability of the system and makes the user-system interface more efficient (e.g., by helping users to provide proper inputs and reducing errors).

The computer system (e.g., 152) receives, via the first input mechanism (e.g., 200, 210-1, and/or 210-2) corresponding to the first user, a fourth user input (e.g., 225) (e.g., a touch input and/or a physical control input (e.g., rotation of a rotatable input mechanism and/or depression of a depressible input mechanism)), wherein the fourth user input corresponds to a request by the first user to modify the second characteristic; and receives, concurrently with the fourth user input, via a third input mechanism (e.g., 200, 210-1, and/or 210-2) (e.g., a physical input mechanism, a touch-sensitive surface, a touch-sensitive display, a button, a rotatable input mechanism, and/or a rotatable and depressible input mechanism) (e.g., an input mechanism in communication with a computer system (e.g., a smart phone, a smart watch, a tablet, a wearable device, a head-mounted device, and/or a computer system that is part of a platform such as a vehicle system (e.g., a computer system that is built into a vehicle system and/or controls one or more functions of a vehicle (e.g., an automobile))); an input mechanism that is part of a platform such as, e.g., a vehicle; and/or an input mechanism configured to receive input from a user) (e.g., a touch-sensitive surface (e.g., a touch-sensitive display); a mouse; a keyboard; a remote control; a visual input device (e.g., one or more cameras (e.g., an infrared camera, a depth camera, a visible light camera)); an audio input device; a mechanical input device (e.g., a button, a dial, a rotatable input mechanism, and/or a depressible input mechanism) and/or a biometric sensor (e.g., a fingerprint sensor, a face identification sensor, and/or an iris identification sensor)) different from the first input mechanism and corresponding to a third user (e.g., corresponding exclusively to the third user, corresponding to a third seating position of a plurality of seating positions (e.g., a third seating position of a plurality of seating positions in a vehicle cabin), and/or corresponding to a third region within a three-dimensional space (e.g., a third region within a vehicle cabin)) different from the first user, a fifth user input (e.g., the computer system detects concurrent rotation of rotatable input mechanism 214-1 by a first user and rotation of rotatable input mechanism 214-2 by a second user in FIG. 2G) (e.g., a touch input and/or a physical control input (e.g., rotation of a rotatable input mechanism and/or depression of a depressible input mechanism)), wherein the fifth user input corresponds to a request by the third user to modify the second characteristic. In response to concurrently receiving the fourth user input via the first input mechanism and the fifth user input via the third input mechanism: the computer system outputs, via the first input mechanism (e.g., 200, 210-1, and/or 210-2), a first haptic output (e.g., vibration; increased resistance of rotation; and/or increased resistance of movement) indicative of concurrent requests to modify a characteristic; and outputs, via the third input mechanism (e.g., 200, 210-1, and/or 210-2), a second haptic output (e.g., vibration; increased resistance of rotation; and/or increased resistance of movement) indicative of concurrent requests to modify a characteristic (e.g., in response to detecting concurrent rotation of rotatable input mechanisms 214-1 and 214-2 in FIG. 2G by two different users, the computer system outputs haptic outputs via input mechanisms 210-1 and 210-2). Providing a haptic output indicative of concurrent requests to modify a characteristic enhances the operability of the system and makes the user-system interface more efficient (e.g., by helping users to provide proper inputs and reducing errors). Doing so also provides the user with feedback about the state of the system (e.g., the system is receiving concurrent inputs to modify the characteristic), thereby providing improved feedback to the user.

In some embodiments, the computer system (e.g., 152) receives, via the first input mechanism (e.g., 200, 210-1, and/or 210-2) corresponding to the first user, a sixth user input (e.g., 225) (e.g., a touch input and/or a physical control input (e.g., rotation of a rotatable input mechanism and/or depression of a depressible input mechanism)), wherein the sixth user input corresponds to a request by the first user to modify the second characteristic; and receives, concurrently with the sixth user input, via a fourth input mechanism (e.g., 200, 210-1, and/or 210-2) (e.g., a physical input mechanism, a touch-sensitive surface, a touch-sensitive display, a button, a rotatable input mechanism, and/or a rotatable and depressible input mechanism) (e.g., an input mechanism in communication with a computer system (e.g., a smart phone, a smart watch, a tablet, a wearable device, a head-mounted device, and/or a computer system that is part of a platform such as a vehicle system (e.g., a computer system that is built into a vehicle system and/or controls one or more functions of a vehicle (e.g., an automobile))); an input mechanism that is part of a platform such as, e.g., a vehicle; and/or an input mechanism configured to receive input from a user) (e.g., a touch-sensitive surface (e.g., a touch-sensitive display); a mouse; a keyboard; a remote control; a visual input device (e.g., one or more cameras (e.g., an infrared camera, a depth camera, a visible light camera)); an audio input device; a mechanical input device (e.g., a button, a dial, a rotatable input mechanism, and/or a depressible input mechanism) and/or a biometric sensor (e.g., a fingerprint sensor, a face identification sensor, and/or an iris identification sensor)) different from the first input mechanism and corresponding to a fourth user (e.g., corresponding exclusively to the fourth user, corresponding to a fourth seating position of a plurality of seating positions (e.g., a fourth seating position of a plurality of seating positions in a vehicle cabin), and/or corresponding to a fourth region within a three-dimensional space (e.g., a fourth region within a vehicle cabin)) different from the first user, a seventh user input (e.g., a touch input and/or a physical control input (e.g., rotation of a rotatable input mechanism and/or depression of a depressible input mechanism)), wherein the seventh user input corresponds to a request by the fourth user to modify the second characteristic (e.g., in FIG. 2G, the computer system detects concurrent rotation of rotatable input mechanisms 214-1 and 214-2 by different users). In response to concurrently receiving the sixth user input via the first input mechanism and the seventh user input via the fourth input mechanism: in accordance with a determination that a first set of arbitration criteria are satisfied (e.g., the first user has higher authorization than the fourth user (e.g., based on authorization criteria) (e.g., a user that initiated a movie has authority to control playback and/or volume over other users and/or a user that is the next to depart the vehicle has authority to control cabin lighting over other users)); and/or the first user initiated the sixth user input before the fourth user initiated the seventh user input): the computer system modifies the second characteristic based on the sixth user input (e.g., based on rotation of 214-1) without modifying the second characteristic based on the seventh user input (e.g., ignoring the seventh user input) (e.g., ignoring rotation of 214-2); and in accordance with a determination that a second set of arbitration criteria different from the first set of arbitration criteria are satisfied (e.g., the fourth user has higher authorization than the first user (e.g., based on authorization criteria) (e.g., a user that initiated a movie has authority to control playback and/or volume over other users and/or a user that is the next to depart the vehicle has authority to control cabin lighting over other users); and/or the fourth user initiated the seventh user input before the first user initiated the sixth user input): the computer system modifies the second characteristic based on the seventh user input (e.g., based on rotation of 214-2) without modifying the second characteristic based on the sixth user input (e.g., ignoring rotation of 214-1) (e.g., ignoring the sixth user input). Automatically selecting which user input to respond to based on arbitration criteria enhances the operability of the system and makes the user-system interface more efficient (e.g., by helping users to provide proper inputs and reducing errors).

In some embodiments, the first set of arbitration criteria includes a first criterion that is satisfied when the first user initiates the sixth user (e.g., 225) input before the fourth user initiates the seventh user input (e.g., before fourth user begins rotating 214-2); and the second set of arbitration criteria includes a second criterion that is satisfied when the fourth user initiates the seventh user input (e.g., the fourth user begins rotating 214-2) before the first user initiates the sixth user input (e.g., before the first user begins rotating 214-1). In some embodiments, the second characteristic is modified based on which user initiated their user input first. Automatically selecting which user input to respond to based on arbitration criteria enhances the operability of the system and makes the user-system interface more efficient (e.g., by helping users to provide proper inputs and reducing errors).

At a first time, the computer system concurrently receives: an eighth user input (e.g., 225) (e.g., a touch input and/or a physical control input (e.g., rotation of a rotatable input mechanism and/or depression of a depressible input mechanism)) via the first input mechanism (e.g., 200, 212-1, and/or 212-2) corresponding to the first user, wherein the eighth user input corresponds to a request by the first user to modify the second characteristic; and a ninth user input (e.g., rotation of 214-2) (e.g., a touch input and/or a physical control input (e.g., rotation of a rotatable input mechanism and/or depression of a depressible input mechanism)) via the fourth input mechanism (e.g., 200, 212-1, and/or 212-2) corresponding to the fourth user, wherein the ninth user input corresponds to a request by the fourth user to modify the second characteristic (e.g., in FIG. 2G, the computer system detects concurrent rotation of 214-1 and 214-2 by different users). In response to concurrently receiving the eighth user input via the first input mechanism and the ninth user input via the fourth input mechanism: in accordance with a determination that the first set of arbitration criteria are satisfied at the first time, the computer system modifies the second characteristic based on the eighth user input without modifying the second characteristic based on the ninth user input (e.g., ignoring the ninth user input) (e.g., modifies the setting based on rotation of 214-1 while ignoring rotation of 214-2). At a second time subsequent to the first time, the computer system concurrently receives: a tenth user input (e.g., a touch input and/or a physical control input (e.g., rotation of a rotatable input mechanism and/or depression of a depressible input mechanism)) via the first input mechanism corresponding to the first user (e.g., 225), wherein the tenth user input corresponds to a request by the first user to modify the second characteristic; and an eleventh user input (e.g., a touch input and/or a physical control input (e.g., rotation of a rotatable input mechanism and/or depression of a depressible input mechanism)) via the fourth input mechanism corresponding to the fourth user (e.g., rotation of 214-2), wherein the eleventh user input corresponds to a request by the fourth user to modify the second characteristic. In response to concurrently receiving the tenth user input (e.g., 225) via the first input mechanism and the eleventh user input (e.g., rotation of 214-2 in FIG. 2G) via the fourth input mechanism: in accordance with a determination that the second set of arbitration criteria are satisfied at the second time, the computer system modifies the second characteristic based on the eleventh user input without modifying the second characteristic based on the tenth user input (e.g., ignoring the tenth user input) (e.g., modifying the characteristic based on rotation of 214-2 while ignoring rotation of 214-1). In some embodiments, the first set of arbitration criteria and/or the second set of arbitration criteria include criteria that can change over time (e.g., changes in circumstances of one or more users and/or a vehicle). Automatically selecting which user input to respond to based on arbitration criteria enhances the operability of the system and makes the user-system interface more efficient (e.g., by helping users to provide proper inputs and reducing errors).

In some embodiments, the first characteristic (e.g., 208a, 208b, 208c, 208d, 218a, 218b, 218c, and/or 218d) is selected from the group consisting of: a temperature characteristic; a climate characteristic (e.g., modifying temperature and/or intensity of one or more air blower); a seating characteristic (e.g., seat recline, seat height, and/or seat temperature); a lighting characteristic (e.g., light brightness and/or light color); a volume characteristic; a window tint characteristic; a window characteristic (e.g., opening and/or closing a window); and a door characteristic (e.g., opening and/or closing a door). Providing an input mechanism that can be used to modify a first characteristic for a first user or modify a second characteristic for multiple users enhances the operability of the system and makes the user-system interface more efficient by reducing the number of controls and/or input mechanisms required to perform various operations.

In some embodiments, the second characteristic (e.g., 208a, 208b, 208c, 208d, 218a, 218b, 218c, and/or 218d) is selected from the group consisting of: a climate characteristic (e.g., modifying temperature and/or intensity of one or more air blower); a window tint characteristic; and a volume characteristic. Providing an input mechanism that can be used to modify a first characteristic for a first user or modify a second characteristic for multiple users enhances the operability of the system and makes the user-system interface more efficient by reducing the number of controls and/or input mechanisms required to perform various operations.

In some embodiments, the computer system (e.g., 152) receives first information indicative of one or more user inputs (e.g., 240) on an external electronic device (e.g., 230) corresponding to the first user (e.g., a personal electronic device corresponding to the first user (e.g., a smart watch, a smart phone, a tablet, a head-mounted system, and/or a headset)) (e.g., an external electronic device different from the first input mechanism and/or separate from a platform (e.g., a vehicle system (e.g., an automobile)) that includes the first input mechanism), wherein the external electronic device is different from the first input mechanism (e.g., 200, 210-1, and/or 210-2). In response to receiving the first information indicative of one or more user inputs on the external electronic device corresponding to the first user, the computer system modifies the first characteristic for the first user without modifying the first characteristic for the second user (e.g., FIGS. 21-2J). Allowing a user to modify the first characteristic using either the first input mechanism or a personal device, such as a smart phone, enhances the operability of the system and makes the user-system interface more efficient (e.g., by helping users to provide proper inputs and reducing errors).

In some embodiments, the computer system receives, via a fifth input mechanism (e.g., 200, 210-1, and/or 210-2) (e.g., a physical input mechanism, a touch-sensitive surface, a touch-sensitive display, a button, a rotatable input mechanism, and/or a rotatable and depressible input mechanism) (e.g., an input mechanism in communication with a computer system (e.g., a smart phone, a smart watch, a tablet, a wearable device, a head-mounted device, and/or a computer system that is part of a platform such as a vehicle system (e.g., a computer system that is built into a vehicle system and/or controls one or more functions of a vehicle (e.g., an automobile))); an input mechanism that is part of a platform such as, e.g., a vehicle; and/or an input mechanism configured to receive input from a user) (e.g., a touch-sensitive surface (e.g., a touch-sensitive display); a mouse; a keyboard; a remote control; a visual input device (e.g., one or more cameras (e.g., an infrared camera, a depth camera, a visible light camera)); an audio input device; a mechanical input device (e.g., a button, a dial, a rotatable input mechanism, and/or a depressible input mechanism) and/or a biometric sensor (e.g., a fingerprint sensor, a face identification sensor, and/or an iris identification sensor)) different from the first input mechanism and corresponding to the second user (e.g., corresponding exclusively to the second user, corresponding to a second seating position of a plurality of seating positions (e.g., a second seating position of a plurality of seating positions in a vehicle cabin), and/or corresponding to a second region within a three-dimensional space (e.g., a second region within a vehicle cabin)), a twelfth user input (e.g., 215 and/or 225) (e.g., a touch input and/or a physical control input (e.g., rotation of a rotatable input mechanism and/or depression of a depressible input mechanism)). In response to receiving the twelfth user input via the fifth input mechanism corresponding to the second user: in accordance with a determination that a third set of criteria are satisfied, the computer system modifies a third characteristic (e.g., a third setting and/or a third vehicle setting) (e.g., audio volume, window tinting, window height (e.g., window open and/or close), display brightness, cabin brightness, temperature, air output intensity, seat incline, and/or seat height) for the second user without modifying the third characteristic for the first user (e.g., FIGS. 2E-2F, in response to user input 215, the first setting is modified for only a single user); and in accordance with a determination that a fourth set of criteria different from the third set of criteria are satisfied, the computer system modifies a fourth characteristic (e.g., a fourth characteristic that is the same as or different from the third characteristic) (e.g., a fourth setting and/or a fourth vehicle setting) (e.g., audio volume, window tinting, window height (e.g., window open and/or close), display brightness, cabin brightness, temperature, air output intensity, seat incline, and/or seat height) for the first user and the second user (e.g., FIGS. 2G-2H, in response to user input 225, the second setting is modified for a plurality of users (as indicated by display of indication 226 on display 220)). Providing an input mechanism that can be used to modify a third characteristic for a second user or modify a fourth characteristic for multiple users enhances the operability of the system and makes the user-system interface more efficient by reducing the number of controls and/or input mechanisms required to perform various operations.

In some embodiments, the computer system (e.g., 152) detects a first set of circumstances (e.g., a first set of circumstances pertaining to one or more users and/or a vehicle (e.g., a vehicle that includes and/or contains the first input mechanism)). In response to detecting the first set of circumstances: the computer system performs a first action corresponding to the first set of circumstances. In some embodiments, performing the first action includes modifying one or more vehicle settings. In some embodiments, performing the first action includes, for example, changing lighting settings (e.g., changing the brightness and/or color of one or more lights); changing audio settings (e.g., increasing and/or decreasing volume); changing display settings (e.g., deploying and/or stowing a displaying; and/or turning a display on or off); changing seat settings (e.g., changing the recline on one or more seats; and/or stowing and/or deploying one or more seats).

In some embodiments, the computer system receives, via the first input mechanism (e.g., 200, 210-1, and/or 210-2), a thirteenth user input (e.g., 215 and/or 225). In response to receiving the thirteenth user input: in accordance with a determination that the first set of criteria are satisfied and the first action is not currently occurring (e.g., the first action is not currently being performed (e.g., by a computer system and/or a vehicle system (e.g., a computer system that is part of a vehicle system)), the computer system modifies the first characteristic for the first user without modifying the first characteristic for the second user; and in accordance with a determination that the first set of criteria are satisfied and the first action is currently occurring (e.g., is currently being performed (e.g., by a computer system and/or a vehicle system (e.g., a computer system that is part of a vehicle system)), the computer system forgoes modifying the first characteristic for the first user (e.g., ignores input 215 and/or 225). In some embodiments, in response to receiving the thirteenth user input (e.g., 215 and/or 225): in accordance with a determination that the second set of criteria are satisfied and the first action is not currently occurring (e.g., the first action is not currently being performed (e.g., by a computer system and/or a vehicle system (e.g., a computer system that is part of a vehicle system)), the computer system modifies the second characteristic for the first user and the second user; and in accordance with a determination that the second set of criteria are satisfied and the first action is currently occurring (e.g., is currently being performed (e.g., by a computer system and/or a vehicle system (e.g., a computer system that is part of a vehicle system)), the computer system forgoes modifying the second characteristic. In some embodiments, when one or more predefined and/or automated actions are taking place, users are not permitted to modify settings (e.g., vehicle settings) during the predefined and/or automated actions. Preventing users from modifying settings when one or more pre-defined actions are taking place enhances the operability of the system and makes the user-system interface more efficient (e.g., by helping users to provide proper inputs and reducing errors).

In some embodiments, the computer system detects a second set of circumstances (e.g., a second set of circumstances pertaining to one or more users and/or a vehicle (e.g., a vehicle that includes and/or contains the first input mechanism)) different from the first set of circumstances. In response to detecting the second set of circumstances, the computer system performs a second action different from the first action and corresponding to the second set of circumstances. In some embodiments, performing the second action includes modifying one or more vehicle settings. In some embodiments, performing the second action includes, for example, changing lighting settings (e.g., changing the brightness and/or color of one or more lights); changing audio settings (e.g., increasing and/or decreasing volume); changing display settings (e.g., deploying and/or stowing a displaying; and/or turning a display on or off); changing seat settings (e.g., changing the recline on one or more seats; and/or stowing and/or deploying one or more seats). In response to receiving the thirteenth user input: in accordance with a determination that the first set of criteria are satisfied and the second action is not currently occurring (e.g., the second action is not currently being performed (e.g., by a computer system and/or a vehicle system (e.g., a computer system that is part of a vehicle system)), the computer system modifies the first characteristic for the first user without modifying the first characteristic for the second user; and in accordance with a determination that the first set of criteria are satisfied and the second action is currently occurring (e.g., is currently being performed (e.g., by a computer system and/or a vehicle system (e.g., a computer system that is part of a vehicle system)), the computer system modifies the first characteristic for the first user without modifying the first characteristic for the second user. In some embodiments, in response to receiving the thirteenth user input: in accordance with a determination that the second set of criteria are satisfied and the second action is not currently occurring (e.g., the second action is not currently being performed (e.g., by a computer system and/or a vehicle system (e.g., a computer system that is part of a vehicle system)), the computer system modifies the second characteristic for the first user and the second user; and in accordance with a determination that the second set of criteria are satisfied and the second action is currently occurring (e.g., is currently being performed (e.g., by a computer system and/or a vehicle system (e.g., a computer system that is part of a vehicle system)), the computer system modifies the second characteristic for the first user and the second user. In some embodiments, when certain predefined and/or automated actions are taking place, users are not permitted to modify settings (e.g., vehicle settings) during the predefined and/or automated actions, but when other predefined and/or automated actions are taking place, users are still able to modify settings. Preventing users from modifying settings when one or more pre-defined actions are taking place but allowing users to modify settings when other pre-defined actions are taking place enhances the operability of the system and makes the user-system interface more efficient (e.g., by helping users to provide proper inputs and reducing errors).

In some embodiments, aspects/operations of methods 300, 400, 600, and/or 800 may be interchanged, substituted, and/or added between these methods. For brevity, these details are not repeated here.

FIG. 4 is a flow diagram of an exemplary method 400 for providing an input mechanism, in accordance with some embodiments. In some embodiments method 400 is performed at a computer system (e.g., computer system 152) and/or a platform (e.g., platform 150). In some embodiments, method 400 is governed by instructions that are stored in a non-transitory (or transitory) computer-readable storage medium and that are executed by one or more processors of a computer system (e.g., 152) or platform (e.g., 150), such as the one or more processors 103 of system 100. Some operations in method 400 are, optionally, combined and/or the order of some operations is, optionally, changed.

In some embodiments, in accordance with (e.g., in response to) a determination that a first set of criteria (in some embodiments, the first set of criteria includes one or more criterion that are satisfied based on a determination about a user interaction and/or user intent to interact with the first input mechanism (e.g., 200, 210-1, and/or 210-2) (e.g., a determination that a hand of the user (e.g., 206) is moving towards the first input mechanism); and/or the first set of criteria include one or more criterion that are satisfied based on an operating state and/or status of a platform (e.g., 150) (e.g., a physical platform, a mobile platform, a vehicle, a vehicle system, an automobile, a vehicle that is in communication with the one or more input devices, and/or a vehicle that includes the one or more input devices) (e.g., a determination that the platform is moving, that the platform is stationary, that the platform is departing a starting location and/or that the platform is approaching a destination location)) are satisfied (402), a computer system (e.g., 152) extends (404) a first input mechanism (e.g., 200, 210-1, 210-2, 204, 214-1, and/or 214-2) (e.g., a physical input mechanism, a button, a rotatable input mechanism, and/or a rotatable and depressible input mechanism) (e.g., a first input mechanism in communication with a computer system (e.g., 152) (e.g., a smart phone, a smart watch, a tablet, a wearable device, a head-mounted device, and/or a computer system that is part of a platform (e.g., 150) such as a vehicle system (e.g., a computer system that is built into a vehicle system and/or controls one or more functions of a vehicle (e.g., an automobile))); a first input mechanism that is part of a platform such as, e.g., a vehicle; and/or a first input mechanism configured to receive input from a user) (e.g., a mechanical input device (e.g., a button, a dial, a rotatable input mechanism, and/or a depressible input mechanism)) from a first surface (e.g., 202, 212-1, and/or 212-2) (e.g., a first surface within a vehicle, a first surface within a vehicle cabin, and/or a first surface of an enclosure that houses (e.g., at least partially encloses) the first input mechanism) (e.g., moving the first input mechanism such that at least a portion of the first input mechanism moves away from the first surface) (e.g., in FIGS. 2B and 2C, mechanical input mechanism 204 extends from 202). In accordance with (e.g., in response to) a determination that a second set of criteria different from the first set of criteria are satisfied (e.g., 406) (e.g., that the first set of criteria are not satisfied) (in some embodiments, the second set of criteria includes one or more criterion that are satisfied based on a determination about a user interaction and/or user intent to interact with the first input mechanism (e.g., 200, 210-1, 210-2, 204, 214-1, and/or 214-2) (e.g., a determination that a hand of the user is not moving towards the first input mechanism and/or the hand of the user is stationary and/or in a position that does not indicate user intent to interact with the first input mechanism); and/or the second set of criteria include one or more criterion that are satisfied based on an operating state and/or status of a platform (e.g., a physical platform, a mobile platform, a vehicle, a vehicle system, an automobile, a vehicle that is in communication with the one or more input devices, and/or a vehicle that includes the one or more input devices) (e.g., a determination that the platform is moving, that the platform is stationary, that the platform is departing a starting location and/or that the platform is approaching a destination location)), the computer system (e.g., 152) forgoes extending (e.g., 408) (e.g., do not extend) the first input mechanism from the first surface (e.g., retracting the first input mechanism into the first surface (e.g., partially retracting and/or fully retracting the first input mechanism into the first surface) (e.g., retracting the first input mechanism to lie flush with the first surface) (e.g., moving the first input mechanism such that at least a portion of the first input mechanism moves toward the first surface)) (e.g., in FIG. 2A, mechanical input mechanism does not extend from surface 202 and/or is retracted into surface 202). Automatically extending the first input mechanism when the first set of criteria are satisfied allows for this operation to be performed without user input, thereby reducing the number of user inputs required to perform an operation. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently. Doing so also provides the user with visual feedback about the state of the system (e.g., the system has determined that the first set of criteria are satisfied), thereby providing improved visual feedback to the user.

In some embodiments, forgoing extending the first input mechanism (e.g., 204) from the first surface (e.g., 202) comprises retracting the first input mechanism into the first surface (e.g., moving at least a portion of the first input mechanism into and/or behind the first surface) (e.g., in FIG. 2A, mechanical input mechanism 204 is retracted into surface 202). Automatically retracting the first input mechanism when the second set of criteria are satisfied allows for this operation to be performed without user input, thereby reducing the number of user inputs required to perform an operation. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, extending the first input mechanism (e.g., 204) from the surface (e.g., 202) comprises extending the first input mechanism from the surface by a first amount (e.g., the first input mechanism extends from the first surface by the first amount)) (e.g., in FIG. 2C, 204 is extended from 202 by a first amount). In accordance with a determination that a third set of criteria (in some embodiments, the third set of criteria includes one or more criterion that are satisfied based on a determination about a user interaction and/or user intent to interact with the first input mechanism (e.g., a determination that a hand of the user is moving towards the first input mechanism); and/or the third set of criteria include one or more criterion that are satisfied based on an operating state and/or status of a platform (e.g., a physical platform, a mobile platform, a vehicle, a vehicle system, an automobile, a vehicle that is in communication with the one or more input devices, and/or a vehicle that includes the one or more input devices) (e.g., a determination that the platform is moving, that the platform is stationary, that the platform is departing a starting location and/or that the platform is approaching a destination location)) different from the first set of criteria and the second set of criteria are satisfied, the computer system extends the first input mechanism (e.g., 204) from the first surface (e.g., 202) by a second amount different from the first amount, wherein the second amount is less than the first amount (e.g., in FIG. 2B, 204 is extended from 202 by a second amount that is less than the first amount in FIG. 2C). Automatically extending the first input mechanism by the first amount when the first set of criteria are satisfied and by the second amount when the third set of criteria are satisfied allows for this operation to be performed without user input, thereby reducing the number of user inputs required to perform an operation. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, when the first input mechanism (e.g., 204) is extended from the surface (e.g., 202) by the first amount (e.g., FIG. 2C), the first input mechanism is configured to receive rotational inputs (e.g., the first input mechanism and/or a computer system in communication with the first input mechanism is configured to detect rotation of the first input mechanism by a user and/or the amount of rotation of the first input mechanism by a user when the first input mechanism is extended by the first amount) and press inputs (e.g., the first input mechanism and/or a computer system in communication with the first input mechanism is configured to detect when the first input mechanism is pushed and/or pressed by a user when the first input mechanism is extended by the first amount); and when the first input mechanism (e.g., 204) is extended from the surface (e.g., 202) by the second amount (e.g., FIG. 2B), the first input mechanism is not configured to receive rotational inputs (e.g., the first input mechanism and/or a computer system in communication with the first input mechanism is not configured to detect rotation of the first input mechanism by a user and/or the amount of rotation of the first input mechanism by a user when the first input mechanism is extended by the second amount) and is configured to receive press inputs (e.g., the first input mechanism and/or a computer system in communication with the first input mechanism is configured to detect when the first input mechanism is pushed and/or pressed by a user when the first input mechanism is extended by the second amount). Configuring the first input mechanism to receive rotation and press inputs when extended by the first amount, and only press inputs when extended by the second amount, enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, when the first input mechanism (e.g., 204) is extended (e.g., when the first input mechanism is fully extended from the surface and, in some embodiments, not when the first input mechanism is only partially extended from the surface) from the surface (e.g., FIG. 2C), the first input mechanism is configured to receive rotational inputs (e.g., the first input mechanism and/or a computer system in communication with the first input mechanism is configured to detect rotation of the first input mechanism by a user and/or the amount of rotation of the first input mechanism by a user when the first input mechanism is extended from the surface). Configuring the first input mechanism to receive rotation inputs when extended enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, when the first input mechanism (e.g., 204) is not extended from the surface (e.g., 202) (e.g., is retracted into and/or behind the surface) (e.g., FIG. 2A), the first input mechanism is not configured to receive rotational inputs (e.g., the first input mechanism and/or a computer system in communication with the first input mechanism is not configured to detect rotation of the first input mechanism by a user and/or the amount of rotation of the first input mechanism by a user when the first input mechanism is not extended from the surface) and is configured to receive press inputs (e.g., the first input mechanism and/or a computer system in communication with the first input mechanism is configured to detect when the first input mechanism is pushed and/or pressed by a user when the first input mechanism is not extended from the surface). Configuring the first input mechanism to receive rotation inputs when extended, and only press inputs when retracted, enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the first set of criteria includes a first criterion that is satisfied when it is determined that a hand of a user (e.g., 206) is moving towards the first input mechanism (e.g., 204) (e.g., FIGS. 2A-2C). Automatically extending the first input mechanism when the first set of criteria are satisfied allows for this operation to be performed without user input, thereby reducing the number of user inputs required to perform an operation. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently. Doing so also provides the user with visual feedback about the state of the system (e.g., the system has determined that the first set of criteria are satisfied), thereby providing improved visual feedback to the user.

In some embodiments, while the first input mechanism (e.g., 204) is extended from the first surface (e.g., 202) (e.g. while the first input mechanism is in a deployed and/or extended state), the computer system receives, via the first input mechanism (e.g., 204), a first user input (e.g., a press input and/or a rotation input). The computer system detects termination of the first user input (e.g., detecting that the user has ceased physical contact with the first input mechanism and/or has moved his or her hand away from the first input mechanism). In response to detecting termination of the first user input, retracts the first input mechanism into the first surface (e.g., moving at least a portion of the first input mechanism into and/or behind the first surface) (e.g., from FIGS. 2C to 2D, input mechanism 204 is retracted back into surface 202). Automatically retracting the first input mechanism when the user is no longer interacting with the first input mechanism allows for this operation to be performed without user input, thereby reducing the number of user inputs required to perform an operation.

In some embodiments, the first input mechanism (e.g., 204) is part of a vehicle system (e.g., platform 150) (e.g., an automobile) (e.g., is built into a vehicle, is mounted within a vehicle, is located within a vehicle, and/or controls one or more functions and/or settings of a vehicle); and the first set of criteria includes a second criterion that is satisfied when the vehicle system is in transit (e.g., is moving, is driving, and/or is traveling towards a destination location). In some embodiments, the first input mechanism extends from the surface when the vehicle system is in transit. Automatically extending the first input mechanism a vehicle is in transit allows for this operation to be performed without user input, thereby reducing the number of user inputs required to perform an operation.

In some embodiments, the first input mechanism (e.g., 204) is part of a vehicle system (e.g., platform 150) (e.g., an automobile) (e.g., is built into a vehicle, is mounted within a vehicle, is located within a vehicle, and/or controls one or more functions and/or settings of a vehicle); and the second set of criteria includes a third criterion that is satisfied when the vehicle system is not in transit (e.g., is not moving, is not driving, and/or is not traveling towards a destination location). In some embodiments, the first input mechanism does not extend from the surface (e.g., is maintained in a stowed and/or retracted state) when the vehicle system is not in transit. Forgoing extending the first input mechanism when the vehicle system is not in transit enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the first input mechanism (e.g., 204) is part of a vehicle system (e.g., platform 150) (e.g., an automobile) (e.g., is built into a vehicle, is mounted within a vehicle, is located within a vehicle, and/or controls one or more functions and/or settings of a vehicle); and the second set of criteria includes a fourth criterion that is satisfied when the vehicle system has arrived at a destination location (e.g., when the vehicle is approaching a destination location; when the vehicle has stopped at a destination location; and/or when it is detected that a user is about to leave the vehicle (e.g., is packing up, is getting up, and/or is standing in the vehicle)). In some embodiments, the first input mechanism does not extend from the surface (e.g., is maintained in a stowed and/or retracted state) when the vehicle system is at a destination location. Forgoing extending the first input mechanism when the vehicle system is at a destination location enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, aspects/operations of methods 300, 400, 600, and/or 800 may be interchanged, substituted, and/or added between these methods. For brevity, these details are not repeated here.

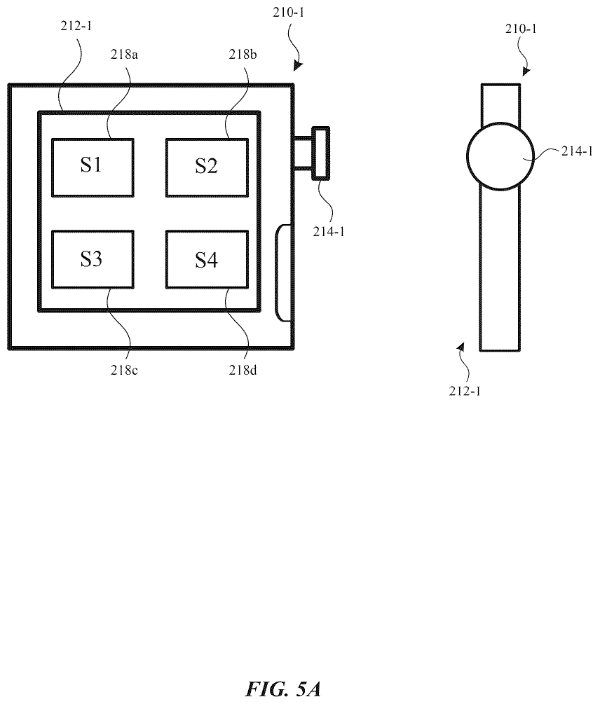

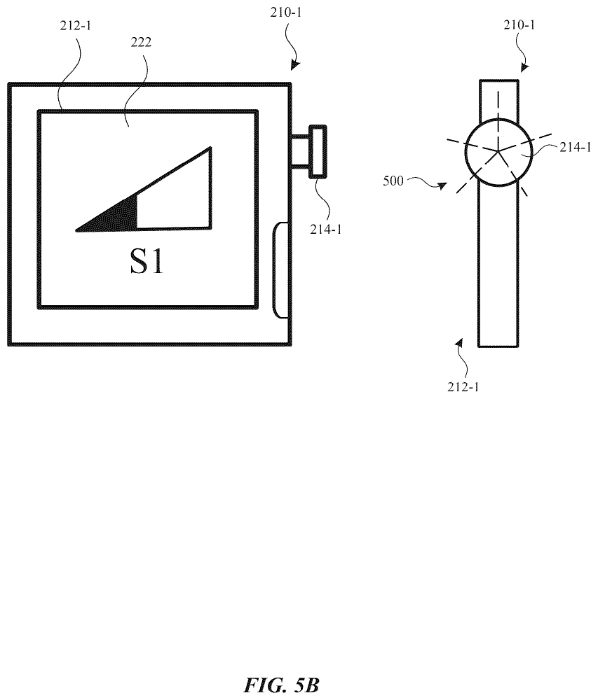

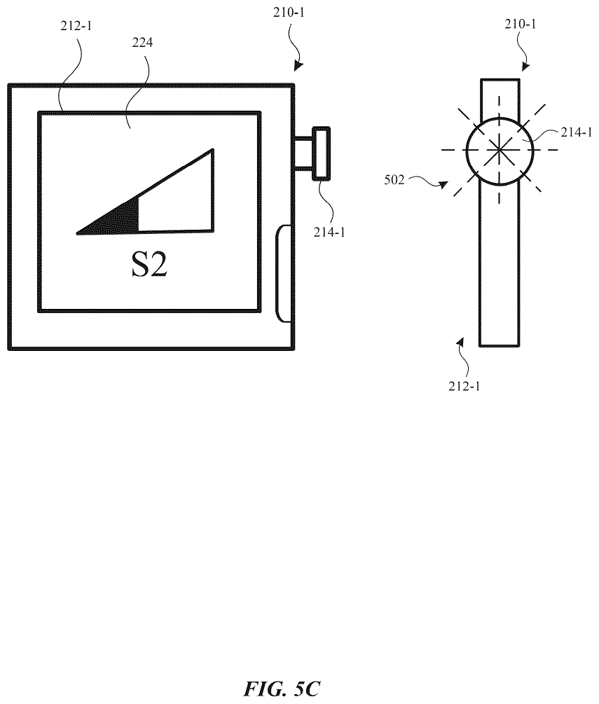

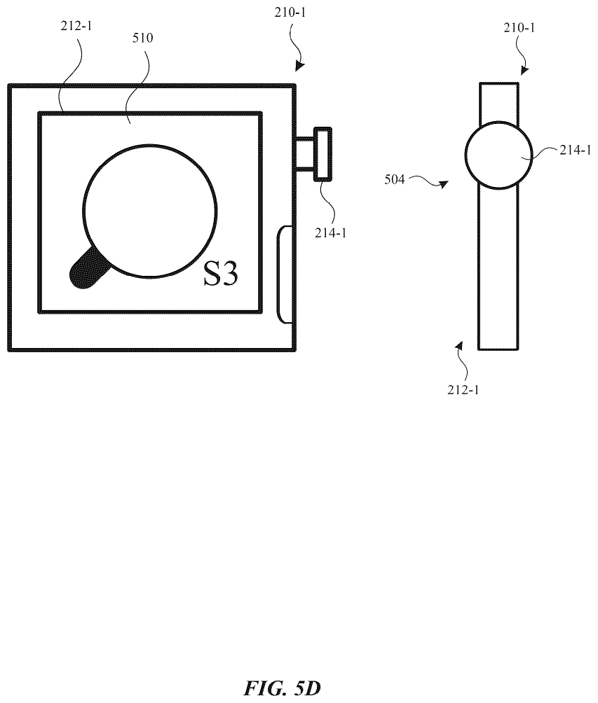

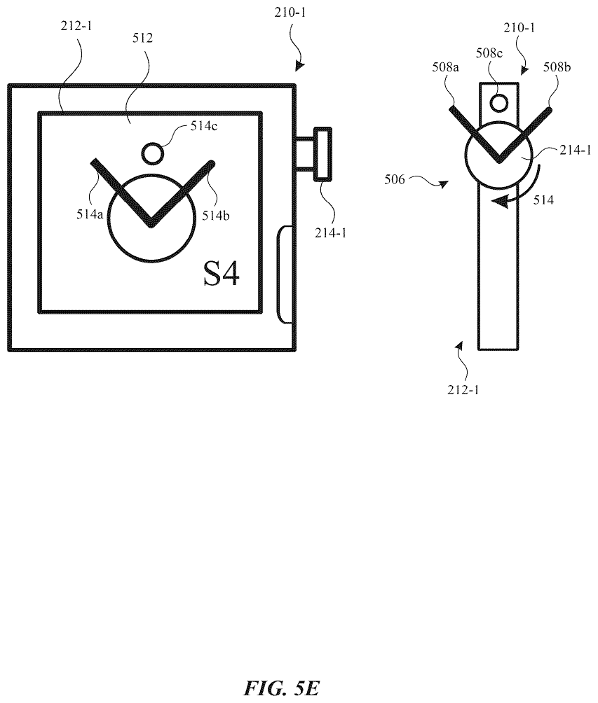

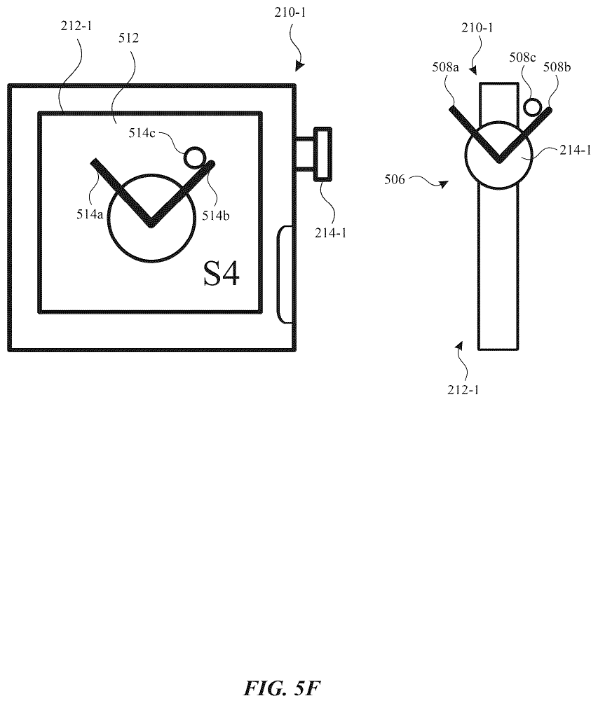

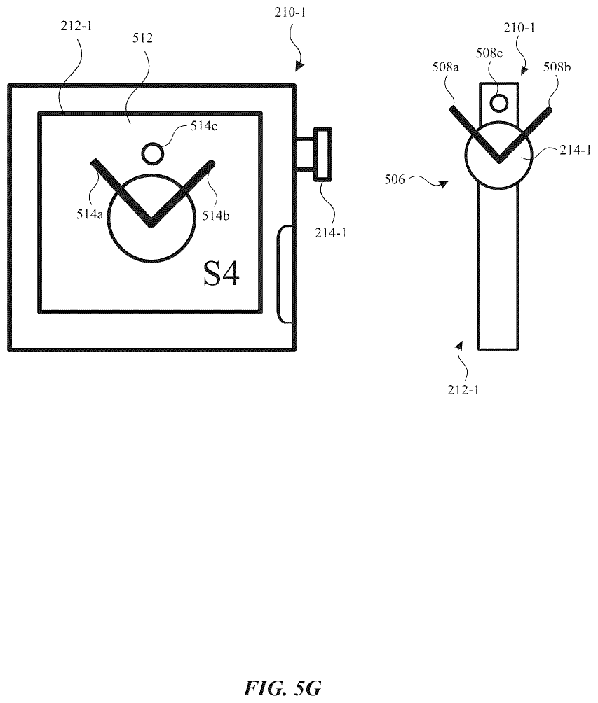

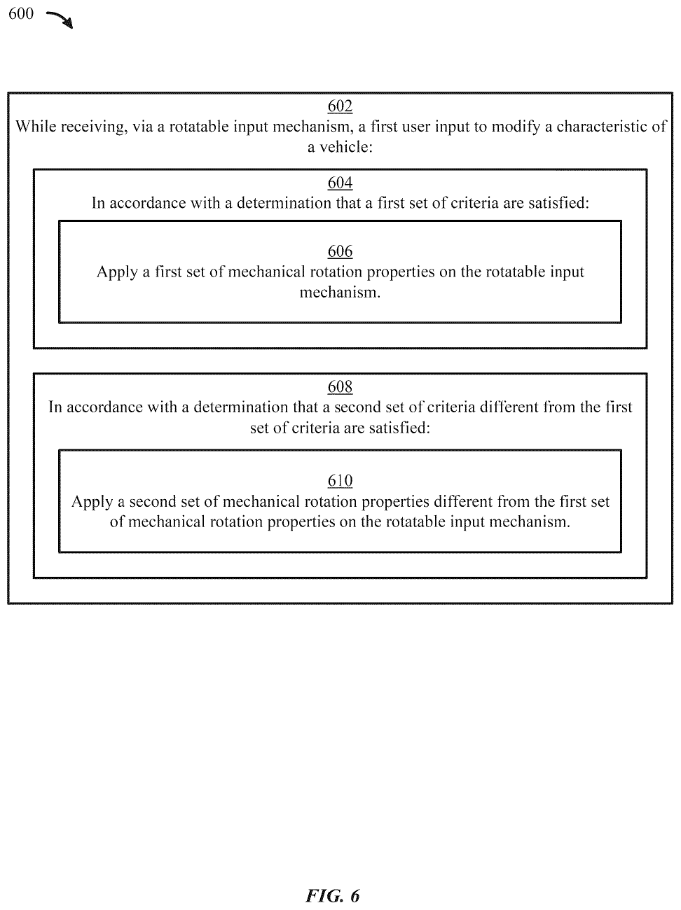

FIGS. 5A-5G illustrate example techniques for modifying one or more mechanical properties of an input mechanism, in accordance with some embodiments. FIG. 6 is a flow diagram of an exemplary method 600 for modifying one or more mechanical properties of an input mechanism, in accordance with some embodiments. The example embodiments shown in FIGS. 5A-5G are used to illustrate the processes described below, including the processes in FIG. 6.

FIG. 5A depicts electronic device 210-1, which is a smart watch with touch-sensitive display 212-1 and rotatable and depressible input mechanism 214-1. FIGS. 5A-5G provide both a front plan view (left) and a side plan view (right) of electronic device 210-1 in order to more clearly demonstrate some of the features disclosed herein. In some embodiments described below, electronic device 210-1 is a smart watch, as depicted in FIGS. 5A-5G. In other embodiments, electronic device 210-1 is an input mechanism that has the same form and function as input mechanism 200 described above, and has a touch-based input portion 202 (e.g., touch-screen display 212-1) and a mechanical input portion 204 (e.g., rotatable and depressible input mechanism 214-1), wherein the mechanical input portion 204 is movable between a plurality of deployment configurations, as discussed above with reference to FIGS. 2A-2D. In various embodiments described herein, any features and/or functions described with reference to electronic device 210-1 is also attributable to input mechanism 200; any features and/or functions described with reference to touch-sensitive display 212-1 is also attributable to touch-based input portion 202; and any features and/or functions described with reference to rotatable and depressible input mechanism 214-1 is also attributable to mechanical input portion 204. In some embodiments, electronic device 210-1 is a computer system (e.g., computer system 152).

At FIG. 5A, electronic device 210-1 displays user interface 216, which includes selectable options 218a-218d. As discussed above, options 218a-218d correspond to respective settings (e.g., respective vehicle settings and/or respective home settings), and are selectable to modify the respective setting (e.g., by rotating rotatable and depressible input mechanism 214-1). FIGS. 5B-5G depict example scenarios in which different mechanical rotation properties are applied to rotatable and depressible input mechanism 214-1 based on which setting is being modified (e.g., based on which object 218a-218d is selected). For example, in various embodiments, mechanical rotation properties include the frequency and/or number of detents that are applied during rotation of rotatable and depressible input mechanism 214-1, rotation limits that are applied to rotation of rotatable and depressible input mechanism 214-1, and/or self-centering of rotatable and depressible input mechanism 214-1.

FIG. 5B depicts a first example scenario in which a user has selected option 218a, corresponding to a first setting. In response to the user selection of option 218a, electronic device 210-1 displays user interface 222 corresponding to the first setting. Furthermore, in response to user selection of option 218a, electronic device 210-1 also applies a first set of mechanical rotation properties 500 to rotatable and depressible input mechanism 214-1, as indicated by the dashed lines. The dashed lines indicate that the first set of mechanical rotation properties applied to input mechanism 214-1 cause input mechanism 214-1 to output a “detent” (e.g., a click and/or haptic output) when it is rotated in 72 degrees in either direction. In FIG. 5B, the

FIG. 5C depicts a second example scenario in which a user has selected option 218b, corresponding to a second setting. In response to the user selection of option 218b, electronic device 210-1 displays user interface 224 corresponding to the second setting. Furthermore, in response to user selection of option 218b, electronic device 210-1 also applies a second set of mechanical rotation properties 502 to rotatable and depressible input mechanism 214-1, as indicated by the dashed lines. The dashed lines in FIG. 5C indicate that the second set of mechanical rotation properties applied to input mechanism 214-1 cause input mechanism 214-1 to output a detent when it is rotated in 45 degrees in either direction. Accordingly, the second setting corresponds to more frequent detents than the first setting shown in FIG. 5B. the second set of mechanical rotation properties 502 also allow for unlimited rotation in either direction.

FIG. 5D depicts a third example scenario in which a user has selected option 218c, corresponding to a third setting. In response to user selection of option 218c, electronic device 210-1 displays user interface 510, corresponding to the third setting. Furthermore, in response to user selection of option 218c, electronic device 210-1 also applies a third set of mechanical rotation properties 504 to rotatable and depressible input mechanism 214-1. The third set of mechanical rotation properties 504 does not include any detents (e.g., as indicated by the lack of dashed lines in FIG. 5D), and also allows for unlimited rotation in either direction.

FIG. 5E depicts a fourth example scenario in which a user has selected option 218d, corresponding to a fourth setting. In response to user selection of option 218d, electronic device 210-1 displays user interface 512, corresponding to the third setting. Furthermore, in response to user selection of option 218d, electronic device 210-1 also applies a fourth set of mechanical rotation properties 506 to rotatable and depressible input mechanism 214-1. The fourth set of mechanical rotation properties 506 includes a first rotation limit, as indicated by line 508a, and a second rotation limit, as indicated by line 508b. In FIG. 5E, rotatable and depressible input mechanism 214-1 can only be rotated by 60 degrees to the left of center, at which point rotation will be stopped, and can only be rotated by 60 degrees to the right of center, at which point rotation will again be stopped. User interface 512 includes line 514a, representative of the first rotation limit, and line 514b, representative of the second rotation limit. User interface 512 also includes a position indication 514c to show the user how far the user has rotated rotatable and depressible input mechanism. In FIG. 5E, electronic device 210-1 is shown with position indication 508c to demonstrate various features.

In FIG. 5E, the fourth set of mechanical rotation properties 506 also includes a self-centering feature that was not part of the first through third sets of mechanical rotation properties described above. In FIG. 5E, electronic device 210-1 detects user input 514, which is rotation of rotatable and depressible input mechanism 214-1 in the clockwise direction.

At FIG. 5F, in response to user input 514, rotatable and depressible input mechanism 214-1 is rotated in the clockwise direction by sixty degrees, and then forced to stop by second rotation limit 508b. At FIG. 5F, the user ceases user input 514 (e.g., lets go of rotatable and depressible input mechanism 214-1 and/or stops applying clockwise force to rotatable and depressible input mechanism 214-1). Once the user ceases user input 514, the self-centering feature causes automatic rotation of rotatable and depressible input mechanism 214-1 to a centered position, as shown in FIG. 5G.

Additional descriptions regarding FIGS. 5A-5G are provided below in reference to method 600 described with respect to FIG. 6.

FIG. 6 is a flow diagram of an exemplary method 600 for modifying one or more mechanical properties of an input mechanism, in accordance with some embodiments. In some embodiments method 600 is performed at a computer system (e.g., computer system 152) and/or a platform (e.g., platform 150). In some embodiments, method 600 is governed by instructions that are stored in a non-transitory (or transitory) computer-readable storage medium and that are executed by one or more processors of a computer system (e.g., 152) or platform (e.g., 150), such as the one or more processors 103 of system 100. Some operations in method 600 are, optionally, combined and/or the order of some operations is, optionally, changed.

In some embodiments, while receiving, via a rotatable input mechanism (e.g., 214-1 and/or 204) (e.g., a physical input mechanism, and/or a rotatable and depressible input mechanism) (e.g., a rotatable input mechanism in communication with a computer system (e.g., a smart phone, a smart watch, a tablet, a wearable device, a head-mounted device, and/or a computer system that is part of a platform such as a vehicle system (e.g., a computer system that is built into a vehicle system and/or controls one or more functions of a vehicle (e.g., an automobile))); a rotatable input mechanism that is part of a platform such as, e.g., a vehicle; and/or a rotatable input mechanism configured to receive input from a user), a first user input (e.g., 215 and/or 225) (e.g., rotation of the rotatable input mechanism) to modify a characteristic of a vehicle (602) (e.g., audio volume, window tinting, window height (e.g., window open and/or close), display brightness, cabin brightness, temperature, air output intensity, seat incline, and/or seat height): in accordance with a determination that a first set of criteria are satisfied (604), a computer system (e.g., 152) applies (606) a first set of mechanical rotation properties (e.g., 500, 502, 504, and/or 506) on the rotatable input mechanism (e.g., a first number and/or a first frequency of rotation detents, a first rotational distance between detents, a first rotational resistance, a first rotational friction, a first rotational torque, a first rotation limit (e.g., a starting limit and/or ending limit to rotation of the rotatable input mechanism), and/or a first rotation range); and in accordance with a determination that a second set of criteria different from the first set of criteria are satisfied (608), the computer system applies (610) a second set of mechanical rotation properties (e.g., 500, 502, 504, and/or 506) (e.g., a second number and/or a second frequency of rotation detents, a second rotational distance between detents, a second rotational resistance, a second rotational friction, a second rotational torque, a second rotation limit (e.g., a starting limit and/or ending limit to rotation of the rotatable input mechanism), and/or a second rotation range) different from the first set of mechanical rotation properties on the rotatable input mechanism.

In some embodiments, at a first time, while receiving, via a rotatable input mechanism (e.g., 204 and/or 214-1) (e.g., a physical input mechanism, and/or a rotatable and depressible input mechanism) (e.g., a rotatable input mechanism in communication with a computer system (e.g., a smart phone, a smart watch, a tablet, a wearable device, a head-mounted device, and/or a computer system that is part of a platform such as a vehicle system (e.g., a computer system that is built into a vehicle system and/or controls one or more functions of a vehicle (e.g., an automobile))); a rotatable input mechanism that is part of a platform such as, e.g., a vehicle; and/or a rotatable input mechanism configured to receive input from a user), a first user input (e.g., 215 and/or 225) (e.g., rotation of the rotatable input mechanism) to modify a first characteristic of a vehicle (e.g., audio volume, window tinting, window height (e.g., window open and/or close), display brightness, cabin brightness, temperature, air output intensity, seat incline, and/or seat height): in accordance with a determination that a first set of criteria are satisfied at the first time, the computer system applies a first set of mechanical rotation properties (e.g., 500, 502, 504, and/or 506) (e.g., a first number and/or a first frequency of rotation detents, a first rotational distance between detents, a first rotational resistance, a first rotational friction, a first rotational torque, a first rotation limit (e.g., a starting limit and/or ending limit to rotation of the rotatable input mechanism), and/or a first rotation range) on the rotatable input mechanism; and at a second time subsequent to the first time, while receiving, via the rotatable input mechanism, a second user input (e.g., 215 and/or 225) to modify a second characteristic of the vehicle (e.g., a second characteristic that is the same as the first characteristic or different from the first characteristic) (e.g., audio volume, window tinting, window height (e.g., window open and/or close), display brightness, cabin brightness, temperature, air output intensity, seat incline, and/or seat height): in accordance with a determination that a second set of criteria (e.g., a second set of criteria different from the first set of criteria) are satisfied at the second time, the computer system applies a second set of mechanical rotation properties (e.g., 500, 502, 504, and/or 506) different from the first set of mechanical rotation properties on the rotatable input mechanism. Providing an input mechanism that is able to switch between different mechanical rotation properties in different circumstances enhances the operability of the system and makes the user-system interface more efficient by reducing the number of controls and/or input mechanisms required to perform various operations. Furthermore, doing so also provides the user with feedback about the state of the system (e.g., different detents and/or other mechanical rotation properties provide the user with feedback about the manner in which the system is modifying various characteristics based on user interaction with the input mechanism), thereby providing improved feedback to the user.

In some embodiments, the first set of criteria includes a first criterion that is satisfied when a first characteristic is selected for the rotatable input mechanism (e.g., setting 1 is selected in FIG. 5B) (e.g., a user has provided one or more user inputs selecting the first characteristic from a plurality of characteristics for the rotatable input mechanism); and the second set of criteria includes a second criterion that is satisfied when a second characteristic (e.g., setting 2 is selected in FIG. 5C) different from the first characteristic is selected for the rotatable input mechanism (e.g., a user has provided one or more user inputs selecting the second characteristic from a plurality of characteristics for the rotatable input mechanism). Providing an input mechanism that is able to control multiple vehicle characteristics, and switching between different mechanical rotation properties based on which vehicle characteristic is currently selected for the input mechanism enhances the operability of the system and makes the user-system interface more efficient by reducing the number of controls and/or input mechanisms required to perform various operations. Furthermore, doing so also provides the user with feedback about the state of the system (e.g., different detents and/or other mechanical rotation properties provide the user with feedback about the manner in which the system is modifying various characteristics based on user interaction with the input mechanism), thereby providing improved feedback to the user.

In some embodiments, the first characteristic is a volume characteristic (e.g., audio volume). Providing an input mechanism that is able to control multiple vehicle characteristics, and switching between different mechanical rotation properties based on which vehicle characteristic is currently selected for the input mechanism enhances the operability of the system and makes the user-system interface more efficient by reducing the number of controls and/or input mechanisms required to perform various operations. Furthermore, doing so also provides the user with feedback about the state of the system (e.g., different detents and/or other mechanical rotation properties provide the user with feedback about the manner in which the system is modifying various characteristics based on user interaction with the input mechanism), thereby providing improved feedback to the user.

In some embodiments, the first characteristic is a climate characteristic (e.g., temperature and/or air blower intensity). Providing an input mechanism that is able to control multiple vehicle characteristics, and switching between different mechanical rotation properties based on which vehicle characteristic is currently selected for the input mechanism enhances the operability of the system and makes the user-system interface more efficient by reducing the number of controls and/or input mechanisms required to perform various operations. Furthermore, doing so also provides the user with feedback about the state of the system (e.g., different detents and/or other mechanical rotation properties provide the user with feedback about the manner in which the system is modifying various characteristics based on user interaction with the input mechanism), thereby providing improved feedback to the user.

In some embodiments, the first characteristic is a window tinting characteristic (e.g., the rotatable input mechanism (e.g., 204 and/or 214-1) is configured to control and/or change the darkness, opacity, and/or level of tint applied to one or more windows (e.g., one or more windows of a vehicle)). Providing an input mechanism that is able to control multiple vehicle characteristics, and switching between different mechanical rotation properties based on which vehicle characteristic is currently selected for the input mechanism enhances the operability of the system and makes the user-system interface more efficient by reducing the number of controls and/or input mechanisms required to perform various operations. Furthermore, doing so also provides the user with feedback about the state of the system (e.g., different detents and/or other mechanical rotation properties provide the user with feedback about the manner in which the system is modifying various characteristics based on user interaction with the input mechanism), thereby providing improved feedback to the user.

In some embodiments, the first characteristic is a window opening characteristic (e.g., the rotatable input mechanism (e.g., 204 and/or 214-1) is configured to control opening and/or closing of one or more windows (e.g., one or more windows of a vehicle)). Providing an input mechanism that is able to control multiple vehicle characteristics, and switching between different mechanical rotation properties based on which vehicle characteristic is currently selected for the input mechanism enhances the operability of the system and makes the user-system interface more efficient by reducing the number of controls and/or input mechanisms required to perform various operations. Furthermore, doing so also provides the user with feedback about the state of the system (e.g., different detents and/or other mechanical rotation properties provide the user with feedback about the manner in which the system is modifying various characteristics based on user interaction with the input mechanism), thereby providing improved feedback to the user.

In some embodiments, applying the first set of mechanical rotation properties on the rotatable input mechanism (e.g., 204 and/or 214-1) comprises applying one or more rotation detents to the rotatable input mechanism (e.g., in FIG. 5B, the first set of mechanical rotation properties 500 includes detents every 72 degrees of rotation; in FIG. 5C, the second set of mechanical rotation properties 502 includes detents every 45 degrees of rotation) (e.g., causing the rotatable input mechanism to provide a haptic output (e.g., a vibration and/or a click) when the rotatable input mechanism is rotated by a predetermined and/or threshold amount (e.g., x degrees or y degrees)); and applying the second set of mechanical rotation properties on the rotatable input mechanism comprises forgoing applying rotation detents to the rotatable input mechanism (e.g., FIG. 5D, mechanical rotation properties 504 includes no detents) (e.g., the rotatable input mechanism is rotatable without the rotatable input mechanism providing a haptic output). Providing an input mechanism that is able to switch between different mechanical rotation properties in different circumstances enhances the operability of the system and makes the user-system interface more efficient by reducing the number of controls and/or input mechanisms required to perform various operations. Furthermore, doing so also provides the user with feedback about the state of the system (e.g., different detents and/or other mechanical rotation properties provide the user with feedback about the manner in which the system is modifying various characteristics based on user interaction with the input mechanism), thereby providing improved feedback to the user.

In some embodiments, applying the first set of mechanical rotation properties on the rotatable input mechanism comprises defining a first amount of rotation between rotation detents (e.g., in FIG. 5B, the first set of mechanical rotation properties 500 includes detents every 72 degrees of rotation; in FIG. 5C, the second set of mechanical rotation properties 502 includes detents every 45 degrees of rotation) (e.g., causing the rotatable input mechanism to provide a haptic output (e.g., a vibration and/or a click) when the rotatable input mechanism is rotated by the first amount of rotation); and applying the second set of mechanical rotation properties on the rotatable input mechanism comprises defining a second amount of rotation between rotation detents, wherein the second amount of rotation is different from the first of rotation (e.g., in FIG. 5B, the first set of mechanical rotation properties 500 includes detents every 72 degrees of rotation; in FIG. 5C, the second set of mechanical rotation properties 502 includes detents every 45 degrees of rotation) (e.g., causing the rotatable input mechanism to provide a haptic output (e.g., a vibration and/or a click) when the rotatable input mechanism is rotated by the second amount of rotation). Providing an input mechanism that is able to switch between different mechanical rotation properties in different circumstances enhances the operability of the system and makes the user-system interface more efficient by reducing the number of controls and/or input mechanisms required to perform various operations. Furthermore, doing so also provides the user with feedback about the state of the system (e.g., different detents and/or other mechanical rotation properties provide the user with feedback about the manner in which the system is modifying various characteristics based on user interaction with the input mechanism), thereby providing improved feedback to the user.

In some embodiments, applying the first set of mechanical rotation properties on the rotatable input mechanism comprises defining a first rotation limit (e.g., 508a) and a second rotation limit (e.g., 508b) (e.g., a first rotation limit that prevents the user from rotating the rotatable input mechanism past a first point in the counterclockwise direction, and a second rotation limit that prevents the user from rotating the rotatable input mechanism past a second point in the clockwise direction); and applying the second set of mechanical rotation properties on the rotatable input mechanism comprises permitting unlimited rotation of the rotatable input mechanism (e.g., 500, 502, 504 in FIGS. 5B-5D include no rotation limits and/or allow for unlimited rotation) (e.g., forgoing setting any rotation limits; and/or allowing for unlimited rotation of the rotatable input mechanism in both the counterclockwise and clockwise directions). Providing an input mechanism that is able to switch between different mechanical rotation properties in different circumstances enhances the operability of the system and makes the user-system interface more efficient by reducing the number of controls and/or input mechanisms required to perform various operations. Furthermore, doing so also provides the user with feedback about the state of the system (e.g., different detents and/or other mechanical rotation properties provide the user with feedback about the manner in which the system is modifying various characteristics based on user interaction with the input mechanism), thereby providing improved feedback to the user.

In some embodiments, applying the first set of mechanical rotation properties on the rotatable input mechanism comprises applying a self-centering feature to the rotatable input mechanism (e.g., FIGS. 5E-5G) (e.g., after completion of a user input rotating the rotatable input mechanism, causing the rotatable input mechanism to rotate in the opposite direction back to a “default” or “centered” position); and applying the second set of mechanical rotation properties on the rotatable input mechanism comprises forgoing applying the self-centering feature to the rotatable input mechanism (e.g., 500, 502, 504 in FIGS. 5B-5D do not include a self-centering feature) (e.g., the rotatable input mechanism does not rotate on its own without user input; and/or after completion of a user input rotating the rotatable input mechanism, the rotatable input mechanism does not rotate on its own). Providing an input mechanism that is able to switch between different mechanical rotation properties in different circumstances enhances the operability of the system and makes the user-system interface more efficient by reducing the number of controls and/or input mechanisms required to perform various operations. Furthermore, doing so also provides the user with feedback about the state of the system (e.g., different detents and/or other mechanical rotation properties provide the user with feedback about the manner in which the system is modifying various characteristics based on user interaction with the input mechanism), thereby providing improved feedback to the user.

In some embodiments, aspects/operations of methods 300, 400, 600, and/or 800 may be interchanged, substituted, and/or added between these methods. For brevity, these details are not repeated here.

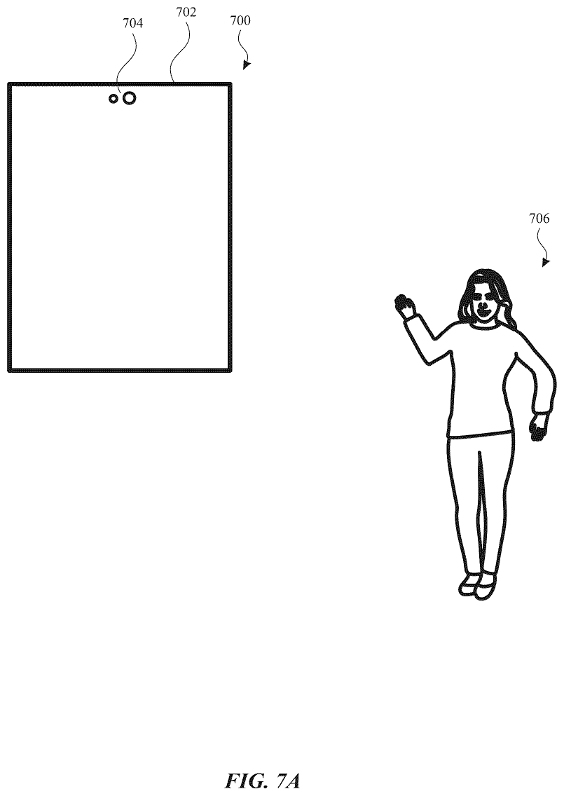

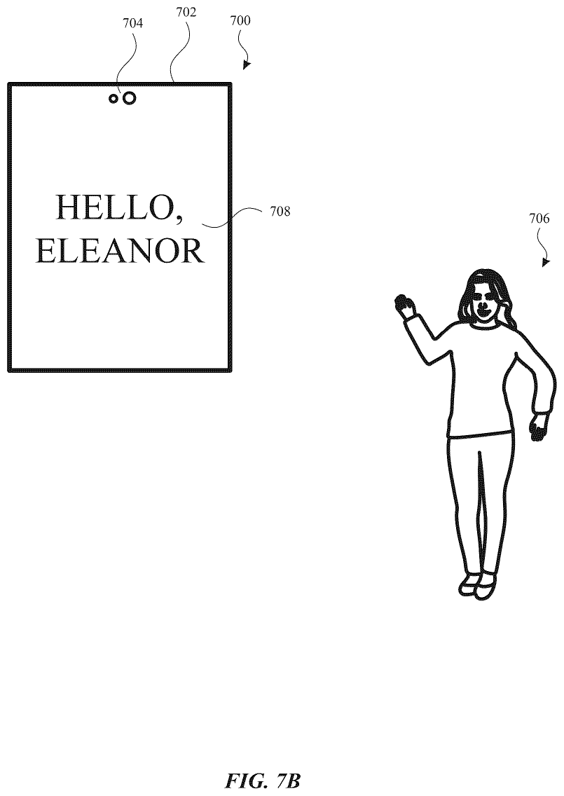

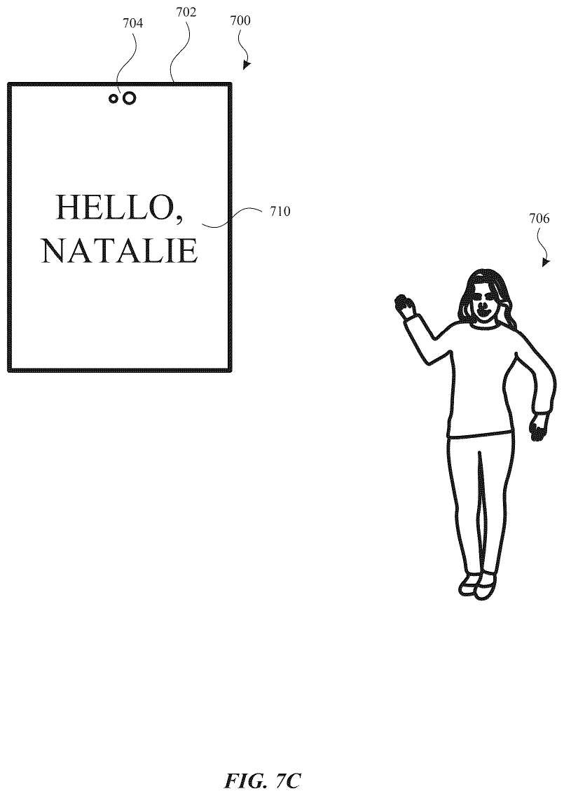

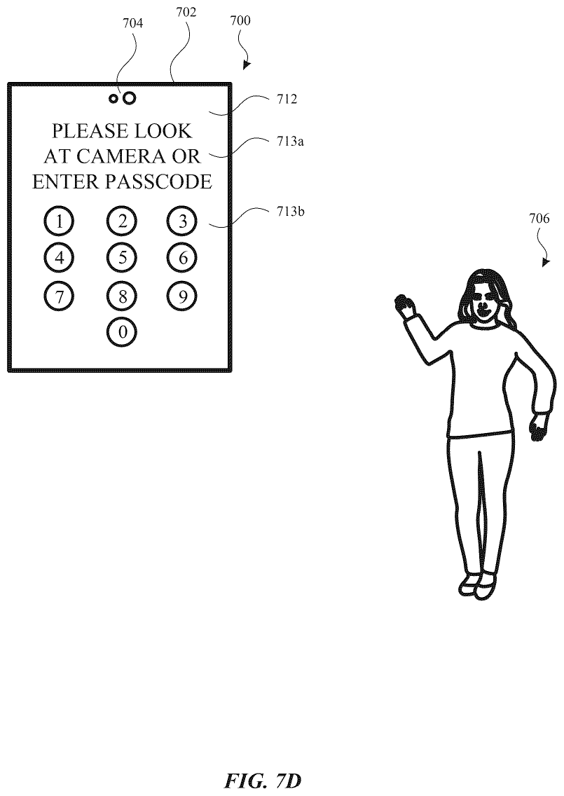

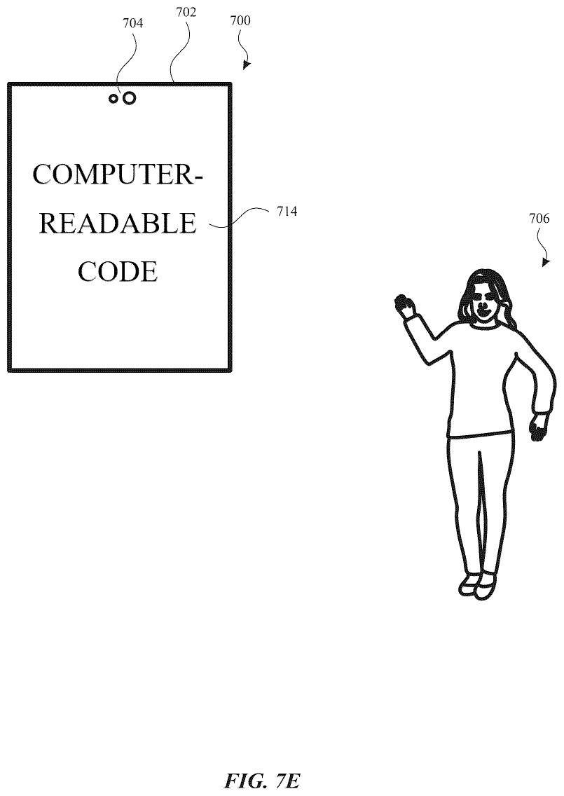

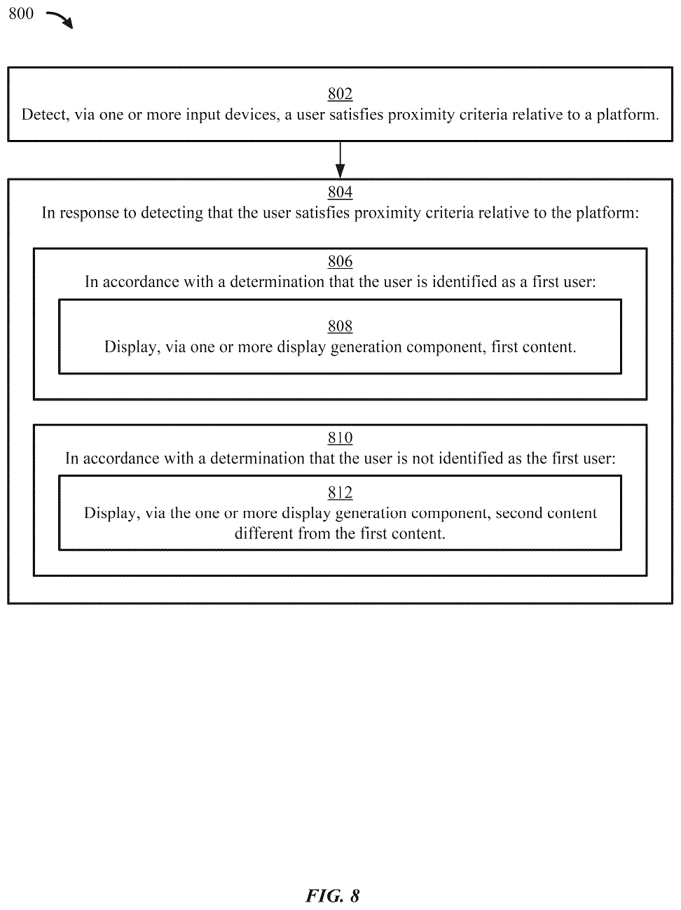

FIGS. 7A-7E illustrate example techniques for displaying content, in accordance with some embodiments. FIG. 8 is a flow diagram of an exemplary method 800 for displaying content, in accordance with some embodiments. The example embodiments shown in FIGS. 7A-7E are used to illustrate the processes described below, including the processes in FIG. 8.

FIG. 7A depicts platform 700, which includes display 702 and input sensors 704 (e.g., one or more cameras, one or more gaze trackers, one or more proximity sensors, one or more motion sensors, and/or one or more Bluetooth connectivity sensors). In some embodiments, display 702 is a touch-sensitive display. In some embodiments, platform 700 is a vehicle system (e.g., an automobile). In some embodiments, platform 700 is a smart home platform and/or a home automation platform. In some embodiments, display 702 is positioned on an exterior portion of platform 700 (e.g., is positioned on an exterior portion of a vehicle and/or is positioned on an exterior portion of a home) such that users approaching platform 700 are able to view display 702. In FIG. 7A, platform 700 detects that user 706 is approaching platform 700. FIGS. 7B-7E depict different example scenarios in which different content is displayed on display 702 based on identification of the user and/or based on other context criteria.

In FIG. 7B, platform 700 identifies user 706 as a first user named Eleanor. For example, in various embodiments, platform 700 identifies user 706 based on facial recognition, based on biometric information, based on one or more images captured by input sensors 704, and/or based on one or more personal devices being carried by and/or worn by user 706 (e.g., based on wireless communication with the one or more personal devices being carried by and/or worn by user 706). At FIG. 7B, in response to identifying user 706 as the first user, and in response to detecting that user 706 is approaching platform 700, display 702 displays first content 708 corresponding to the first user. As discussed above, in some embodiments, platform 700 is a vehicle, and display 702 is affixed to and/or faces the exterior of the vehicle. In some embodiments, first content 708 includes additional information pertaining to the first user, such as a destination address that the first user is traveling to, identification of an event that the first user is traveling to, and/or identification of an event that the first user is leaving. Furthermore, in some embodiments, in response to identifying user 706 as the first user, and in response to detecting that user 706 is approaching platform 700, platform 700 performs additional actions, such as unlocking and/or opening a door to provide access to the interior of platform 700 (e.g., provide access to a vehicle cabin). In some embodiments, platform 700 displays first content 708 based on one or more criteria indicating that user 706 intends to interact with platform 700, such as a determination that user 706 is looking at platform 700 and/or user 706 is walking towards platform 700.

FIG. 7C depicts an alternative scenario in which platform 700 identifies user 706 as a second user named Natalie. At FIG. 7C, in response to identifying user 706 as the second user, and in response to detecting that user 706 is approaching platform 700, display 702 displays second content 710 corresponding to the second user. As discussed above, in some embodiments, second content 710 includes additional information pertaining to the second user, such as a destination address that the second user is traveling to, identification of an event that the second user is traveling to, and/or identification of an event that the second user is leaving. Furthermore, in some embodiments, in response to identifying user 706 as the second user, and in response to detecting that user 706 is approaching platform 700, platform 700 performs additional actions, such as unlocking and/or opening a door to provide access to the interior of platform 700 (e.g., provide access to a vehicle cabin and/or provide access to the interior of a home). In some embodiments, platform 700 displays second content 710 based on one or more criteria indicating that user 706 intends to interact with platform 700, such as a determination that user 706 is looking at platform 700 and/or user 706 is walking towards platform 700.

FIG. 7D depicts a third scenario, in which platform 700 does not identify user 706 as a known user, or fails to identify user 706. In FIG. 7D, in response to this determination, display 702 displays authentication user interface 712, which includes instruction 713a that asks the user to provide biometric information to authentication the user and also includes keypad 713b for the user to enter authentication information and/or identifying information (e.g., via one or more touch inputs on touch-sensitive display 702) to authenticate and/or identify the user.

In some embodiments, platform 700 displays content on display 702 based on other context information other than the identity of a user approaching platform 700. For example, in some embodiments, if platform 700 is available to be rented and/or purchased, platform 700 displays a payment user interface that allows a user to enter payment information to rent platform 700 (e.g., for a ride to a destination). In another example, if platform 700 is approaching a scenario in which a user inside platform 700 (e.g., a user riding a vehicle and/or a user inside a home) needs to provide information (e.g., payment information and/or identifying information) to an entity outside of platform 700, display 702 displays the payment information and/or the identifying information. For example, FIG. 7E displays an example scenario in which platform 700 is driving through a service area, such as a restaurant drive through or a car wash, and a user within platform 700 must provide payment information to a person outside platform 700 (e.g., to user 706). In FIG. 7E, in response to determining that platform 700 is driving through a service area and that payment information must be presented, platform 700 displays QR code 714 which can be scanned by user 706 to obtain payment information for the user within platform 700.

Additional descriptions regarding FIGS. 7A-7E are provided below in reference to method 800 described with respect to FIG. 8.

FIG. 8 is a flow diagram of an exemplary method 800 for displaying content, in accordance with some embodiments. In some embodiments method 800 is performed at a computer system (e.g., computer system 152) and/or a platform (e.g., platform 150). In some embodiments, method 800 is governed by instructions that are stored in a non-transitory (or transitory) computer-readable storage medium and that are executed by one or more processors of a computer system (e.g., 152) or platform (e.g., 150), such as the one or more processors 103 of system 100. Some operations in method 800 are, optionally, combined and/or the order of some operations is, optionally, changed.

In some embodiments, a computer system (e.g., 152) detects (802), via one or more input devices (e.g., 704, 156, and/or 158) (e.g., one or more computer systems (e.g., a smart phone, a smart watch, a tablet, a wearable device, a head-mounted device); one or more input devices in communication with a computer system (e.g., a smart phone, a smart watch, a tablet, a wearable device, a head-mounted device, and/or a computer system that is part of a platform such as a vehicle system (e.g., a computer system that is built into a vehicle system and/or controls one or more functions of a vehicle (e.g., an automobile))); one or more input devices that are part of a platform such as, e.g., a vehicle; a remote control; a visual input device (e.g., one or more cameras (e.g., an infrared camera, a depth camera, a visible light camera)); an audio input device; a mechanical input device (e.g., a button, a dial, a rotatable input mechanism, and/or a depressible input mechanism) and/or a biometric sensor (e.g., a fingerprint sensor, a face identification sensor, and/or an iris identification sensor)), a user (e.g., 706) satisfies proximity criteria relative to a platform (e.g., 700) (e.g., a physical platform, a mobile platform, a vehicle, a vehicle system, an automobile, a vehicle that is in communication with the one or more input devices, and/or a vehicle that includes the one or more input devices) (e.g., the user is within a threshold proximity and/or the user is within a threshold distance of the platform) (in some embodiments, the computer system detects that a user is approaching a platform (e.g., is within a threshold proximity and/or within a threshold distance of the platform and is moving towards the platform)). In response to detecting that the user satisfies proximity criteria relative to the platform (804) (and, in some embodiments, without detecting and/or receiving user inputs (e.g., intentional user inputs, button presses, interaction with a user interface, and/or touch inputs) from the user): in accordance with a determination that the user is identified as a first user (806) (e.g., a first known user and/or a first registered user) (e.g., based on biometric information corresponding to the user (e.g., facial scan and/or iris scan); based on automated facial recognition; based on one or more images and/or videos of the user; and/or based on user information received from a computer system corresponding to the user (e.g., user information and/or user account information wireless transmitted from the computer system corresponding to the user to the platform and/or a computer system corresponding to the platform), the computer system displays (808), via one or more display generation components (e.g., 702), first content (e.g., 708, 710, 712, and/or 714) (e.g., first content corresponding to (e.g., tailored for and/or specific to) the first user); and in accordance with a determination that the user is not identified as the first user (810) (e.g., the user is not identified as a known and/or registered user, and/or the user is identified as a second user (e.g., a second known user and/or a second registered user) different from the first user) (e.g., based on biometric information corresponding to the user (e.g., facial scan and/or iris scan); based on automated facial recognition; based on one or more images and/or videos of the user; and/or based on user information received from a computer system corresponding to the user (e.g., user information and/or user account information wireless transmitted from the computer system corresponding to the user to the platform and/or a computer system corresponding to the platform), the computer system displays (812), via the one or more display generation components (e.g., 702), second content (e.g., 708, 710, 712, and/or 714) different from the first content. Automatically displaying first content when the user is identified as a first user and automatically displaying second content when the user is not identified as the first user allows for these operations to be performed with fewer user inputs, thereby reducing the number of user inputs required to perform an operation. Furthermore, doing so also provides the user with visual feedback about the state of the system (e.g., whether the system has identified the user as the first user), thereby providing improved visual feedback to the user.

In some embodiments, the first content (e.g., 708 and/or 710) includes a name of the first user (e.g., the one or more display generation components display the name of the first user). Automatically displaying first content when the user is identified as a first user and automatically displaying second content when the user is not identified as the first user allows for these operations to be performed with fewer user inputs, thereby reducing the number of user inputs required to perform an operation. Furthermore, doing so also provides the user with visual feedback about the state of the system (e.g., whether the system has identified the user as the first user), thereby providing improved visual feedback to the user.

In some embodiments, the first content (e.g., 708, 710, 712, and/or 714) includes a destination location corresponding to the first user (e.g., a destination location that the first user is traveling to; a destination location that the user has identified as the user's intended destination) (e.g., an address, a city, and/or a geographic location). Automatically displaying first content when the user is identified as a first user and automatically displaying second content when the user is not identified as the first user allows for these operations to be performed with fewer user inputs, thereby reducing the number of user inputs required to perform an operation. Furthermore, doing so also provides the user with visual feedback about the state of the system (e.g., whether the system has identified the user as the first user), thereby providing improved visual feedback to the user.

In some embodiments, in response to detecting that the user satisfies proximity criteria relative to the platform: in accordance with a determination that the user is identified as the first user: the computer system provides the user with physical access to an interior portion of the platform (e.g., 700) (e.g., an interior cabin (e.g., an interior cabin of a vehicle (e.g., unlocking a door and/or opening a door for the user to access the interior portion of the platform))). In some embodiments, in response to detecting that the user satisfies proximity criteria relative to the platform: in accordance with a determination that the user is not identified as the first user, the computer system forgoes providing the user with physical access to the interior portion of the platform. Automatically providing a user with access to the interior portion of a platform (e.g., interior of a vehicle) based on the user being identified as a first user allows for these operations to be performed with fewer user inputs, thereby reducing the number of user inputs required to perform an operation. Furthermore, doing so also provides the user with visual feedback about the state of the system (e.g., whether the system has identified the user as the first user), thereby providing improved visual feedback to the user.

In some embodiments, providing the user with physical access to the interior portion of the platform comprises opening a door that provides access to the interior portion of the platform (e.g., opening a vehicle door that provides access to the interior cabin of the vehicle). In some embodiments, in response to detecting that the user satisfies proximity criteria relative to the platform: in accordance with a determination that the user is not identified as the first user, the computer system forgoes providing the user with physical access to the interior portion of the platform, including maintaining the door in a closed position. Automatically providing a user with access to the interior portion of a platform (e.g., interior of a vehicle) based on the user being identified as a first user allows for these operations to be performed with fewer user inputs, thereby reducing the number of user inputs required to perform an operation. Furthermore, doing so also provides the user with visual feedback about the state of the system (e.g., whether the system has identified the user as the first user), thereby providing improved visual feedback to the user.

In some embodiments, providing the user with physical access to the interior portion of the platform comprises unlocking a door that provides access to the interior portion of the platform (e.g., unlocking a vehicle door that provides access to the interior cabin of the vehicle). In some embodiments, in response to detecting that the user satisfies proximity criteria relative to the platform: in accordance with a determination that the user is not identified as the first user, the computer system forgoes providing the user with physical access to the interior portion of the platform, including maintaining the door in a locked state. Automatically providing a user with access to the interior portion of a platform (e.g., interior of a vehicle) based on the user being identified as a first user allows for these operations to be performed with fewer user inputs, thereby reducing the number of user inputs required to perform an operation. Furthermore, doing so also provides the user with visual feedback about the state of the system (e.g., whether the system has identified the user as the first user), thereby providing improved visual feedback to the user.

In some embodiments, in response to detecting that the user satisfies proximity criteria relative to the platform: in accordance with a determination that the user is identified as a second user different from the first user (e.g., a second known user and/or a second registered user) (e.g., based on biometric information corresponding to the user (e.g., facial scan and/or iris scan); based on automated facial recognition; based on one or more images and/or videos of the user; and/or based on user information received from a computer system corresponding to the user (e.g., user information and/or user account information wireless transmitted from the computer system corresponding to the user to the platform and/or a computer system corresponding to the platform), the computer system displays, via the one or more display generation components (e.g., 702), third content (e.g., 708, 710, 712, and/or 714) different from the first content (e.g., third content corresponding to the second user). Automatically displaying first content when the user is identified as a first user and automatically displaying third content when the user is identified as a second user allows for these operations to be performed with fewer user inputs, thereby reducing the number of user inputs required to perform an operation. Furthermore, doing so also provides the user with visual feedback about the state of the system (e.g., whether the system has identified the user as the first user or the second user), thereby providing improved visual feedback to the user.

In some embodiments, the third content (e.g., 708 and/or 710) includes a name of the second user (e.g., the one or more display generation components display the name of the second user). Automatically displaying first content when the user is identified as a first user and automatically displaying third content when the user is identified as a second user allows for these operations to be performed with fewer user inputs, thereby reducing the number of user inputs required to perform an operation. Furthermore, doing so also provides the user with visual feedback about the state of the system (e.g., whether the system has identified the user as the first user or the second user), thereby providing improved visual feedback to the user.

In some embodiments, the third content (e.g., 708, 710, 712, and/or 714) includes a second destination location corresponding to the second user (e.g., a destination location that the second user is traveling to; a destination location that the user has identified as the user's intended destination) (e.g., an address, a city, and/or a geographic location). Automatically displaying first content when the user is identified as a first user and automatically displaying third content when the user is identified as a second user allows for these operations to be performed with fewer user inputs, thereby reducing the number of user inputs required to perform an operation. Furthermore, doing so also provides the user with visual feedback about the state of the system (e.g., whether the system has identified the user as the first user or the second user), thereby providing improved visual feedback to the user.

In some embodiments, the second content comprises an authentication user interface (e.g., 712) that includes one or more selectable objects (e.g., 713b) that are selectable by a user to enter user authentication information (e.g., user identification information (e.g., user name and/or user identifier), password information, and/or user keycode information). Automatically displaying an authentication user interface when the user is not identified as the first user allows for these operations to be performed with fewer user inputs, thereby reducing the number of user inputs required to perform an operation. Furthermore, doing so also provides the user with visual feedback about the state of the system (e.g., whether the system has identified the user as the first user), thereby providing improved visual feedback to the user.

In some embodiments, the authentication user interface (e.g., 712) comprises a keypad (e.g., 713b) comprising a plurality of selectable keys (e.g., a number pad and/or a keyboard) that are selectable by a user to enter user authentication information (e.g., user identification information (e.g., user name and/or user identifier), password information, and/or user keycode information). Automatically displaying an authentication user interface when the user is not identified as the first user allows for these operations to be performed with fewer user inputs, thereby reducing the number of user inputs required to perform an operation. Furthermore, doing so also provides the user with visual feedback about the state of the system (e.g., whether the system has identified the user as the first user), thereby providing improved visual feedback to the user.

In some embodiments, the authentication user interface (e.g., 712) includes a first instruction (e.g., 713a) that instructs the user to provide biometric authentication information (e.g., instructs the user to look at a camera, instructs the user to look at a face scanner, instructs the user to look into an eye scanner, and/or instructs the user to place his or her hand and/or finger on a fingerprint scanner). Automatically displaying an authentication user interface when the user is not identified as the first user allows for these operations to be performed with fewer user inputs, thereby reducing the number of user inputs required to perform an operation. Furthermore, doing so also provides the user with visual feedback about the state of the system (e.g., whether the system has identified the user as the first user), thereby providing improved visual feedback to the user.

In some embodiments, the second content comprises a payment user interface that includes one or more selectable options for the user to enter payment information. In some embodiments, the payment user interface allows a user to enter payment information in order to pay for access to the platform (e.g., in order to pay for access to an interior cabin of the platform (e.g., an interior vehicle cabin)) (e.g., in order to pay for the platform (e.g., a vehicle) to provide transportation to a destination location). Automatically displaying a payment user interface when the user is not identified as the first user allows for these operations to be performed with fewer user inputs, thereby reducing the number of user inputs required to perform an operation. Furthermore, doing so also provides the user with visual feedback about the state of the system (e.g., whether the system has identified the user as the first user), thereby providing improved visual feedback to the user.

In some embodiments, in response to detecting that the user satisfies proximity criteria relative to the platform: in accordance with a determination that the user is not identified as the first user: the computer system prevents physical access to an interior portion of the platform (e.g., an interior cabin (e.g., an interior cabin of a vehicle)) (e.g., locking a door, maintain a door in a locked state, closing a door, and/or maintaining a door in a closed state). Automatically preventing physical access to an interior portion of a platform (e.g., interior of a vehicle) based on the user not being identified as a first user allows for these operations to be performed with fewer user inputs, thereby reducing the number of user inputs required to perform an operation. Furthermore, doing so also provides the user with visual feedback about the state of the system (e.g., whether the system has identified the user as the first user), thereby providing improved visual feedback to the user. Doing so also improves security, by preventing access by unauthorized individuals.

In some embodiments, in accordance with a determination that a first set of scenario criteria indicative of a first scenario are satisfied (e.g., one or more location-based criteria (e.g., determining that the platform is located at a first location), one or more time-based criteria (e.g., based on the current time), one or more user-based criteria (e.g., based on identification of a user (e.g., a user within a proximity of the platform) as a particular user), the computer system displays, via the one or more display generation components (e.g., 702), third content (e.g., 708, 710, 712, and/or 714) (e.g., a QR code, a wallet user interface, a payments user interface, an authentication user interface, a first greeting user interface, and/or a second greeting user interface) corresponding to the first scenario; and in accordance with a determination that a second set of scenario criteria different from the first set of scenario criteria and indicative of a second scenario different from the first scenario are satisfied, e.g., one or more location-based criteria (e.g., determining that the platform is located at a first location), one or more time-based criteria (e.g., based on the current time), one or more user-based criteria (e.g., based on identification of a user (e.g., a user within a proximity of the platform) as a particular user), the computer system displays, via the one or more display generation components, fourth content (e.g., 708, 710, 712, and/or 714) (e.g., a QR code, a wallet user interface, a payments user interface, an authentication user interface, a first greeting user interface, and/or a second greeting user interface) different from the third content and corresponding to the second scenario. Automatically displaying third content in a first scenario, and displaying fourth content in a second scenario allows for these operations to be performed with fewer user inputs, thereby reducing the number of user inputs required to perform an operation.

In some embodiments, the proximity criteria includes a first interaction criterion that is satisfied when one or more actions by the user (e.g., 706) are determined to indicate an intent to interact with the platform (e.g., 700) (e.g., the user is facing the platform, the user is moving towards the platform, and/or the user speaks one or more words indicative of intent to interact with the platform). Automatically displaying content in response to detecting user behavior indicative of a user intent to interact with the platform allows for these operations to be performed with fewer user inputs, thereby reducing the number of user inputs required to perform an operation.

In some embodiments, aspects/operations of methods 300, 400, 600, and/or 800 may be interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to explain the principles of the techniques and their practical applications. Others skilled in the art are thereby enabled to utilize the techniques and various embodiments with various modifications as are suited to the particular use contemplated.

Although the disclosure and embodiments have been fully described with reference to the accompanying drawings, it is to be noted that various changes and modifications will become apparent to those skilled in the art. Such changes and modifications are to be understood as being included within the scope of the disclosure and embodiments as defined by the claims.

What is claimed is:

1. A computer system, comprising:
one or more processors; and
memory storing one or more programs configured to be executed by the one or more processors, the one or more programs including instructions for:
receiving, via a first input mechanism corresponding to a first user of a plurality of users, a first user input;
in response to receiving the first user input via the first input mechanism corresponding to the first user:
in accordance with a determination that a first set of criteria are satisfied, modifying a first characteristic for the first user without modifying the first characteristic for a second user of the plurality of users; and
in accordance with a determination that a second set of criteria different from the first set of criteria are satisfied, modifying a second characteristic for the first user and for the second user.

2. The computer system of claim 1, wherein:
the first input mechanism comprises a first extendible component that is movable between a plurality of configurations, including a stowed configuration and a first deployed configuration different from the stowed configuration; and
the one or more programs further include instructions for:
while the first extendible component of the first input mechanism is in the stowed configuration:
in accordance with a determination that a set of extension criteria are satisfied, moving the first extendible component from the stowed configuration to the first deployed configuration.

3. The computer system of claim 2, wherein:
the plurality of configurations further includes a second deployed configuration different from the first deployed configuration and the stowed configuration; and
the one or more programs further include instructions for:
while the first extendible component of the first input mechanism is in the stowed configuration:
in accordance with a determination that a second set of extension criteria are satisfied, moving the first extendible component from the stowed configuration to the second deployed configuration.

4. The computer system of claim 1, wherein:
the first input mechanism comprises:
a touch-sensitive input portion configured to receive touch-based user inputs; and
a mechanical input portion configured to receive mechanical user inputs; and
the one or more programs further include instructions for:
receiving, via the touch-sensitive input portion, a selection input corresponding to selection of a first setting of a plurality of settings;
subsequent to receiving the selection input, receiving, via the mechanical input portion, a modification input; and
in response to receiving the modification input, modifying the first setting.

5. The computer system of claim 1, the one or more programs further including instructions for:
in response to receiving the first user input via the first input mechanism:
in accordance with a determination that the first set of criteria are satisfied, displaying, via a first display generation component corresponding to the first input mechanism, an indication that the first characteristic was modified; and
in accordance with a determination that the second set of criteria are satisfied, displaying, via a second display generation component different from the first display generation component, an indication that the second characteristic was modified.

6. The computer system of claim 5, wherein:
displaying the indication that the second characteristic was modified on the second display generation component comprises overlaying the indication that the second characteristic was modified on content that was previously displayed on the second display generation component.

7. The computer system of claim 5, the one or more programs further including instructions for:
displaying, via the second display generation component, first content; and
modifying visual content displayed on the first display generation component based on the first content.

8. The computer system of claim 1, the one or more programs further including instructions for:
receiving, via the first input mechanism corresponding to the first user, a second user input, wherein the second user input corresponds to a request by the first user to modify the second characteristic; and
receiving, concurrently with the second user input, via a second input mechanism different from the first input mechanism and corresponding to a second user different from the first user, a third user input, wherein the third user input corresponds to a request by the second user to modify the second characteristic; and
in response to concurrently receiving the second user input via the first input mechanism and the third user input via the second input mechanism:
in accordance with a determination that the first user is identified as a first type of user:
modifying the second characteristic based on the second user input without modifying the second characteristic based on the third user input.

9. The computer system of claim 1, the one or more programs further including instructions for:
receiving, via the first input mechanism corresponding to the first user, a fourth user input, wherein the fourth user input corresponds to a request by the first user to modify the second characteristic; and
receiving, concurrently with the fourth user input, via a third input mechanism different from the first input mechanism and corresponding to a third user different from the first user, a fifth user input, wherein the fifth user input corresponds to a request by the third user to modify the second characteristic; and
in response to concurrently receiving the fourth user input via the first input mechanism and the fifth user input via the third input mechanism:
outputting, via the first input mechanism, a first haptic output indicative of concurrent requests to modify a characteristic; and
outputting, via the third input mechanism, a second haptic output indicative of concurrent requests to modify a characteristic.

10. The computer system of claim 1, the one or more programs further including instructions for:
receiving, via the first input mechanism corresponding to the first user, a sixth user input, wherein the sixth user input corresponds to a request by the first user to modify the second characteristic; and
receiving, concurrently with the sixth user input, via a fourth input mechanism different from the first input mechanism and corresponding to a fourth user different from the first user, a seventh user input, wherein the seventh user input corresponds to a request by the fourth user to modify the second characteristic; and
in response to concurrently receiving the sixth user input via the first input mechanism and the seventh user input via the fourth input mechanism:
in accordance with a determination that a first set of arbitration criteria are satisfied:
modifying the second characteristic based on the sixth user input without modifying the second characteristic based on the seventh user input; and
in accordance with a determination that a second set of arbitration criteria different from the first set of arbitration criteria are satisfied:
modifying the second characteristic based on the seventh user input without modifying the second characteristic based on the sixth user input.

11. The computer system of claim 10, wherein:
the first set of arbitration criteria includes a first criterion that is satisfied when the first user initiates the sixth user input before the fourth user initiates the seventh user input; and
the second set of arbitration criteria includes a second criterion that is satisfied when the fourth user initiates the seventh user input before the first user initiates the sixth user input.

12. The computer system of claim 10, the one or more programs further including instructions for:
at a first time, concurrently receiving:
an eighth user input via the first input mechanism corresponding to the first user, wherein the eighth user input corresponds to a request by the first user to modify the second characteristic; and
a ninth user input via the fourth input mechanism corresponding to the fourth user, wherein the ninth user input corresponds to a request by the fourth user to modify the second characteristic;
in response to concurrently receiving the eighth user input via the first input mechanism and the ninth user input via the fourth input mechanism:
in accordance with a determination that the first set of arbitration criteria are satisfied at the first time, modifying the second characteristic based on the eighth user input without modifying the second characteristic based on the ninth user input;
at a second time subsequent to the first time, concurrently receiving:
a tenth user input via the first input mechanism corresponding to the first user, wherein the tenth user input corresponds to a request by the first user to modify the second characteristic; and
an eleventh user input via the fourth input mechanism corresponding to the fourth user, wherein the eleventh user input corresponds to a request by the fourth user to modify the second characteristic; and
in response to concurrently receiving the tenth user input via the first input mechanism and the eleventh user input via the fourth input mechanism:
in accordance with a determination that the second set of arbitration criteria are satisfied at the second time, modifying the second characteristic based on the eleventh user input without modifying the second characteristic based on the tenth user input.

13. The computer system of claim 1, wherein the first characteristic is selected from the group consisting of: a temperature characteristic; a climate characteristic; a seating characteristic; a lighting characteristic; a volume characteristic; a window tint characteristic;
a window characteristic; and a door characteristic.

14. The computer system of claim 1, wherein the second characteristic is selected from the group consisting of: a climate characteristic; a window tint characteristic; and a volume characteristic.

15. The computer system of claim 1, the one or more programs further including instructions for:
receiving first information indicative of one or more user inputs on an external electronic device corresponding to the first user, wherein the external electronic device is different from the first input mechanism; and
in response to receiving the first information indicative of one or more user inputs on the external electronic device corresponding to the first user, modifying the first characteristic for the first user without modifying the first characteristic for the second user.

16. The computer system of claim 1, the one or more programs further including instructions for:
receiving, via a fifth input mechanism different from the first input mechanism and corresponding to the second user, a twelfth user input; and
in response to receiving the twelfth user input via the fifth input mechanism corresponding to the second user:
in accordance with a determination that a third set of criteria are satisfied, modifying a third characteristic for the second user without modifying the third characteristic for the first user; and
in accordance with a determination that a fourth set of criteria different from the third set of criteria are satisfied, modifying a fourth characteristic for the first user and the second user.

17. The computer system of claim 1, the one or more programs further including instructions for:
detecting a first set of circumstances; and
in response to detecting the first set of circumstances:
performing a first action corresponding to the first set of circumstances.

18. The computer system of claim 17, the one or more programs further including instructions for:
receiving, via the first input mechanism, a thirteenth user input; and
in response to receiving the thirteenth user input:
in accordance with a determination that the first set of criteria are satisfied and the first action is not currently occurring, modifying the first characteristic for the first user without modifying the first characteristic for the second user; and
in accordance with a determination that the first set of criteria are satisfied and the first action is currently occurring, forgoing modifying the first characteristic for the first user.

19. The computer system of claim 18, the one or more programs further including instructions for:
detecting a second set of circumstances different from the first set of circumstances;
in response to detecting the second set of circumstances:
performing a second action different from the first action and corresponding to the second set of circumstances; and
in response to receiving the thirteenth user input:
in accordance with a determination that the first set of criteria are satisfied and the second action is not currently occurring, modifying the first characteristic for the first user without modifying the first characteristic for the second user; and
in accordance with a determination that the first set of criteria are satisfied and the second action is currently occurring, modifying the first characteristic for the first user without modifying the first characteristic for the second user.

20. A non-transitory computer-readable storage medium storing one or more programs configured to be executed by one or more processors of a computer system, the one or more programs including instructions for:
receiving, via a first input mechanism corresponding to a first user of a plurality of users, a first user input;
in response to receiving the first user input via the first input mechanism corresponding to the first user:
in accordance with a determination that a first set of criteria are satisfied, modifying a first characteristic for the first user without modifying the first characteristic for a second user of the plurality of users; and
in accordance with a determination that a second set of criteria different from the first set of criteria are satisfied, modifying a second characteristic for the first user and for the second user.

21. A method, comprising:
receiving, via a first input mechanism corresponding to a first user of a plurality of users, a first user input;
in response to receiving the first user input via the first input mechanism corresponding to the first user:
in accordance with a determination that a first set of criteria are satisfied, modifying a first characteristic for the first user without modifying the first characteristic for a second user of the plurality of users; and
in accordance with a determination that a second set of criteria different from the first set of criteria are satisfied, modifying a second characteristic for the first user and for the second user.
